(19) United States
(12) Patent Application Publication
(10) Pub. No.: US 2007/0223453 A1
(43) Pub. Date: Sep. 27, 2007

(54) Server and connection destination server switching control method

(75) Inventors: Masaaki Takase, Kawasaki (JP); Takeshi Sano, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/453,447

(22) Filed: Jun. 15, 2006

(30) Foreign Application Priority Data
Mar. 23, 2006 (JP) 2006-081582

(51) Int. Cl. H04L 12/66

(52) U.S. Cl. 370/352; 370/248

(57) ABSTRACT

By providing a load measuring unit measuring the load of a cache server, an overflown load determination unit determining whether the measured load is overflown, by comparing the measured load with a predetermined value, a connection destination retrieval request information transmitting unit transmitting connection destination retrieval request information for requesting to search for the connection destination of a load source cache server, to a contents server if it is determined that the load is overflown, a connection destination information receiving unit receiving connection destination information indicating the retrieved connection destination, from the contents server that has transmitted the connection destination retrieval request information and a switch request transmitting unit transmitting switch request information for requesting to switch the connection to the connection destination indicated by the connection destination information, based on the received connection destination information, the load of each cache server can be distributed.

### BACKGROUND OF THE INVENTION

1. Field of the Invention

The present invention relates to a load distribution technology in a cache technology for reducing the amount of communication of data flowing through a network, and more particularly, relates to a server for reducing the amount of communication of contents data flowing through a contents delivery network for distributing contents according to a request from a client and a connection destination server switching control method for switching the connection destination thereof.

2. Description of the Related Art

Conventionally, as technologies for reducing the amount of communication flowing through a network, there are (1) a cache technology and (2) a mirroring technology. These technologies both copy information owned by a server with contents (hereinafter called a “contents server”) to another place (herein after called a “cache server”) close to a reference requester terminal (hereinafter called a “client”) in the network and reduce the amount of communication of contents flowing through the network by enabling the client to refer to the copy in the cache server.

The cache technology (1) is, in particular, effective when the contents of a contents sever are not modified. However, recently a case where a Web server or the like, for dynamically generating contents when a client accesses it cannot be coped with by simply caching the contents has increased. In order to solve this problem, a technology for increasing the ratio of contents which can be cached, by finely dividing even contents which are dynamically generated as a whole into a dynamic part and a static part and caching only the static part is developed.

As another approach, there is also a technology for also caching dynamic contents and increasing a cache hit ratio by also automatically updating cache if contents are modified.

The mirroring technology (2) is suitable for copying a large amount of data in a specific cycle.

Since the load of such a cache server increases according to the number of requests, a load distribution technology is indispensable. As the method, there are a method using a load distribution controller (for example, see Japanese Patent Application Publication No. 2001-236293), a wide area load distribution using a general server (for example, see Japanese Patent Application Publication No. 2004-507128) and the like. However, in any of them, a case where a cache server is managed by a different manager and a case where its load becomes a problem since files are continuously copied to cache are not taken into consideration.

A technology for modifying the type of the contents distributed by a contents sever, according to the fluctuations of the process load of a cache server, which are measured by a request from a client in a peer to peer-contents delivery network (P2P-CDN) composed of a plurality of contents servers, cache servers for receiving contents delivery from a contents severs and clients is disclosed (for example, see Japanese Patent Application Publication No. 2002-259354).

However, in the load distribution of contents delivery, such as CDN or the like, a fixed logical network configuration composed of a cache server and a client receiving contents delivery is popular. In this case, even when its load is one-sided, the network configuration cannot be modified.

FIG. 1 shows the problem of the prior art.

In (A) of FIG. 1, a CDN 1 comprises one contents server 2, a plurality of cache servers 3 and a plurality of clients 4. The contents server 2 sits on the top, the plurality of cache servers 3 are subordinately connected to the contents server 2 and the plurality of clients 4 are subordinately connected to each cache server 3. Alternatively, as shown in (B) of FIG. 1, another cache server 3 can be subordinately connected to some cache server 3.

Since these cache servers 3 cannot catch the load status of another cache server 3 each other, the CDN 1 where m cache servers 3 are subordinately connected to one contents server 2, as in (A) of FIG. 1 cannot be modified to the CDN 1 where (m-1) cache servers 3 are subordinately connected to one contents server 2 and another cache server 3 is subordinately connected to some of the cache servers 3. Alternatively, conversely the network configuration cannot be modified from (B) to (A) of FIG. 1.

If there is a plurality of contents servers each with different contents, it is difficult to modify a connection destination according to the load status of one cache server since the load of one cache server is calculated for each contents server 2.

However, in the technology called P2P-CDN, a node for receiving contents delivery also operates as a cache server for relaying the contents and there is a node for dynamically modifying a logical network configuration. However, in this case, a case where there is a plurality of contents delivery destinations is not taken into consideration. Therefore, if there is a plurality of contents delivery destinations, the number of cache servers, in proportional to the number of contents delivery destinations is needed, thereby damaging its scalability.

### SUMMARY OF THE INVENTION

It is an object of the present invention to provide a server capable of dynamically modifying a logical network configuration according to the load of each cache server and realizing a larger-scaled network system, by distributing the load to each cache server even when there is a plurality of contents servers, which is contents delivery destinations., specifically even when each cache server is managed by a different manager and a connection destination server switching control method for switching the connection destination of thereof, in order to solve the above-described problem.

It is another object of the present invention to provide a server capable of reducing the amount of communication flowing through a network as a whole by distributing the load of each cache server and a connection destination server switching control method for switching the connection destination of thereof.

In order to solve the above-described problem, the present invention comprises a function to modify the contents acquisition destination of a cache server under the lead of the cache server, a function to reduce the load of a cache server by modifying the connection destination of a subordinate cache server when the cache server is hierarchical and when the load of a specific cache server increases or the number of subordinate cache servers to be referenced decreases, a function to modify the contents acquisition destination of a cache server under a contents server and a function to reduce the load of a specific contents server by modifying the one of the connection destinations of a cache server obtaining the contents to another subordinate cache server when the load of a contents sever increases.

According to one aspect of the present invention, the cache server of the present invention caches and delivers contents in a contents server, according to a request from a client. The cache server comprises a load measuring unit for measuring the load of a cache server, caused by a load source cache server subordinately connected to the cache server caching contents cached in the cache server, an overflown load determination unit for determining whether a load measured by the load measuring unit is overflown, by comparing the load with a predetermined value, a connection destination retrieval request information transmitting unit for transmitting a connection destination retrieval request for requesting a contents sever or another cache server to search for the connection destination of the load source cache server, which is its load source, if the overflown load determination unit determines that the load is overflown, a connection destination information receiving unit for receiving connection destination information indicating the connection destination retrieved by the contents sever or the other cache server from the contents sever or the other cache server, which is a transmitting destination, to which the connection destination retrieval request information transmitting unit has transmitted the connection destination retrieval request information, and a switch request transmitting unit for transmitting a switch request information for requesting the load source cache server to switch the connection to the connection destination indicated in the connection destination information, based on the connection destination information received by the connection destination information receiving unit.

In the cache server of the present invention, it is preferable for the connection destination retrieval request information transmitting unit to transmit the connection destination retrieval request information to a contents sever or the other cache server connected to the cache server in predetermined order.

According to another aspect, the contents server of the present invention comprises a connection destination retrieval request information receiving unit for receiving a connection destination retrieval request for requesting to search for the connection destination of the load source cache server, which is the load source of the cache server, from the above-described cache server, a connection destination retrieval request transfer unit for transferring the connection destination retrieval request information to another cache server subordinately connected to a contents sever received by the connection destination retrieval request information receiving unit, a connection destination possible/impossible determination result receiving unit for receiving a connection destination determination result indicating whether the contents server can be the connection destination of the load source cache server, from the other cache server which is a transfer destination to which the connection destination retrieval request information is transmitted, a connection destination determining unit for determining whether the server can be the connection destination of the load source cache server, based on the load of the contents server if all the connection destination possible/impossible determination results received by the connection destination possible/impossible determination result receiving unit cannot be the connection destination of the load source cache server and a connection destination possible/impossible determination result transmitting unit for transmitting a connection destination possible/impossible determination result indicating whether the server can be the connection destination determined by the connection destination determination unit.

According to another aspect of the present invention, the cache server of the present invention is the above-described other cache server and comprises a connection destination retrieval request information receiving unit for receiving connection destination retrieval request information for requesting to search for the connection destination of a load source cache server which is the load source of the cache server, from the above-described contents server or cache server, a connection destination determination unit for determining whether the contents server can be the connection destination of the load source cache server, based on the load of the cache server, included in the connection destination retrieval request information received by the connection destination retrieval request information receiving unit, a connection destination retrieval request information transfer unit for transferring the connection destination retrieval request information to another cache server subordinately connected to the cache server if the connection destination possible/impossible determination result indicating whether the connection destination determined by the connection destination determination unit can be the connection destination of the load source cache server and a connection destination possible/impossible determination result transmitting unit for transmitting the connection destination possible/impossible determination result indicating whether the connection destination determined by the connection destination determination unit can be the connection destination of the load source cache server, to the contents server or cache server which has transmitted the connection destination retrieval request information.

According to another aspect of the present invention, the connection destination server switching control method of the present invention is implemented in a contents delivery network for delivering contents in a contents server, according to a request from a client. In the method, a load source cache server subordinately connected to the cache server caching contents cached in the cache server measures the load of the cache server and transmits connection destination retrieval request information for requesting to search for the connection destination of a load source cache server, which is its load source, to a contents sever if it is determined that the measured load is overflown by comparing the load with a predetermined value. The contents server receives the connection destination retrieval request information transmitted from the cache server and transfers the received connection destination retrieval request information to another cache server subordinately connected to a contents sever. The other cache server determines whether the contents server can be the connection destination of the load source cache server, based on the load of the other cache server included in the connection destination retrieval request information received by the connection destination retrieval request information receiving unit and transmits the connection destination possible/impossible determination result indicating whether the server can be determined to be the connection destination. Then, the contents server returns the received connection destination possible/impossible determination result to the load source cache server as the determined connection destination. Then, the load source cache server modifies the connection destination, based on the returned connection destination possible/impossible determination result.

Then, if its load increases by providing cache to another cache server, the cache server which directly obtains contents from a contents sever reduces the load of the cache server by modifying the acquisition destination of a part of contents of another cache server to another cache server.

If its load increases by providing cache to another cache server, the cache server which obtains contents from another cache reduces the load of the cache server by modifying the acquisition destination of a part of contents of another cache server to another cache server.

When modifying these connection destinations, the acquisition destination of the contents of a cache server lower by two layers than a contents sever to the contents server. Specifically, the cache server is modified to the highest-order cache server.

If its load increases by providing cache to another cache server, the cache server which provides contents to another cache reduces the load of a contents sever by modifying the acquisition destination of a part of contents of the cache server.

When modifying this connection destination, the acquisition destination of the contents of the highest-order cache server is modified to another cache server. Specifically, the cache server is modified to a two-layer lower cache server.

### BRIEF DESCRIPTION OF THE DRAWINGS

FIG. 1 shows the problem of the prior art;

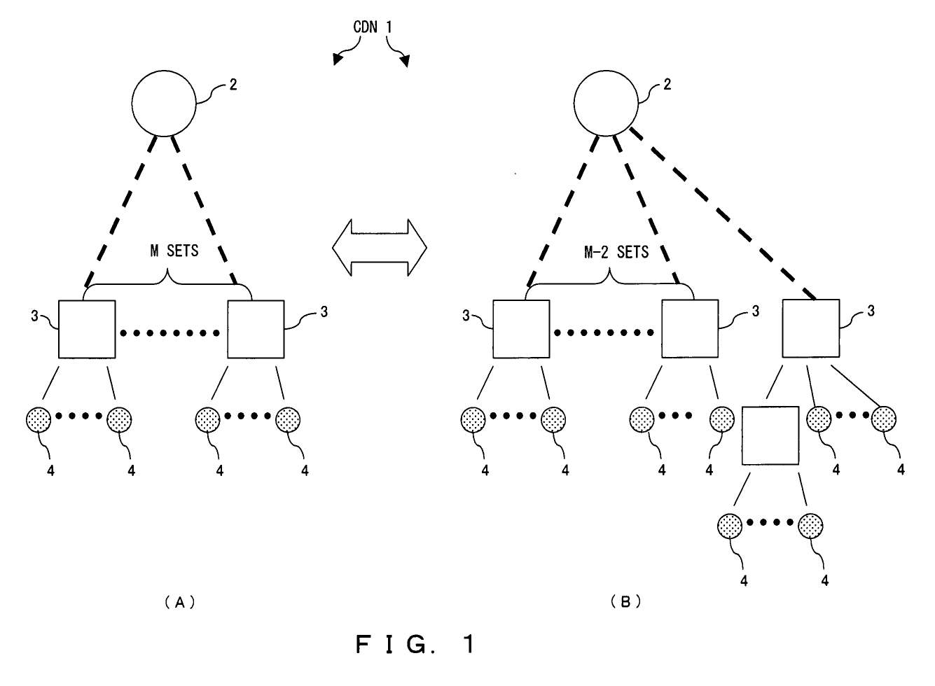

FIG. 2 shows the summary of the present invention;

FIG. 3 shows an example of the network configuration adopting the present invention;

FIG. 4 shows an example of the functional configuration of a contents sever;

FIG. 5 shows an example of the functional configuration of the cache server;

FIG. 6 shows a contents delivery network for showing an example of the operation of the present invention;

FIG. 7 shows an example of the operation of switching the connection destination of a two-order lower cache server to another cache server, due to the load increase of the highest-order cache server;

FIG. 8 shows an example of information included in a connection destination switch request message;

FIG. 9 shows an example of information included in a connection destination switch response message;

FIG. 10 shows an example of information included in a switch destination notice message;

FIG. 11 shows an example of information included in a switch destination response message;

FIG. 12 shows an example of information included in a connection request message;

FIG. 13 shows an example of information included in a connection response message;

FIG. 14 shows an example of the operation of switching the connection destination of a two-layer lower cache server to another two-layer lower cache server, due to the load increase of the highest-order cache server;

FIG. 15 shows an example of information included in a connection destination retrieval request message;

FIG. 16 shows an example of information included in a connection destination retrieval response message;

FIG. 17 shows another example of the operation of switching the connection destination of a two-layer lower cache server to another two-layer lower cache server, due to the load increase of the highest-order cache server;

FIG. 18 shows an example of the operation of switching the connection destination of a two-layer lower cache server to a contents sever, due to the load increase of the highest-order cache server;

FIG. 19 shows an example of the operation in the case where the connection is switched, due to the decrease of overlapped cache contents between a parent cache server and a child cache server;

FIG. 20 shows an example of the operation in the case where a request for switching a connection to a cache server in which overlapped contents to cache is large is received from a contents sever;

FIG. 21 shows an example of the connection destination switching operation in the case where the amount of contents requested by a child cache server relatively increases and the child cache server is directly connected to a contents sever;

FIG. 22 shows an example of the connection destination switching operation in the case where the amount of contents requested by a child cache server relatively increases and the connection of the child cache server is switched to another cache server;

FIG. 23 shows an example of the operation in the case where a failure occurs in a parent cache server and the connection destination of the cache server is modified;

FIG. 24 shows an example of the operation of switching the connection destination of the highest-order cache server to another cache server;

FIG. 25 shows an example of the operation of modifying cache update under the lead of a cache server to cache update under the lead of a contents sever;

FIG. 26 shows an example of the operation of modifying cache update under the lead of a contents sever to cache update under the lead of a cache server;

FIG. 27 shows an example of the operation of a cache server at the time of receiving a connection destination retrieval request;

FIG. 28 shows an example of the operation of a cache server at the time of receiving a connection switch request;

FIG. 29 shows an example of the operation of a cache server at the time of receiving a connection switch response;

FIG. 30 shows an example of the operation of the parent cache server at the time of receiving a switch destination cache server notice;

FIG. 31 shows an example of the operation of a child cache server at the time of receiving a switch destination cache server notice;

FIG. 32 shows an example of the operation of a cache server at the time of receiving a switch destination cache server notice response;

FIG. 33 shows an example of the operation of a cache server at the time of receiving a connect request;

FIG. 34 shows an example of the operation of a cache server at the time of receiving a connect response;

FIG. 35 shows an example of the operation of a cache server of transmitting a child cache server connection switch request to a higher-order server at the time of heavy load;

FIG. 36 shows an example of the operation of a cache server of transmitting a connection switch request to a child cache server at the time of heavy load;

FIG. 37 shows an example of the operation of a contents sever in the case where a connection destination is switched due to the load status of the contents server;

FIG. 38 shows an example of the operation of a contents sever at the time of receiving a connection destination retrieval request;

FIG. 39 shows an example of the operation of a contents sever at the time of receiving a connection destination switch request;

FIG. 40 shows an example of the operation of a contents sever at the time of receiving a connect request;

FIG. 41 shows an example of the operation of a contents sever at the time of receiving a connection destination retrieval response;

FIG. 42 shows an example of the operation of a contents sever at the time of receiving a connection destination switch response;

FIG. 43 shows the hardware configurations of a contents sever and cache server of the present invention; and

FIG. 44 shows how to load the connection destination server switching control program of the present invention onto a computer.

### DESCRIPTION OF THE PREFERRED EMBODIMENTS

The preferred embodiments of the present invention are described below with reference to the drawings.

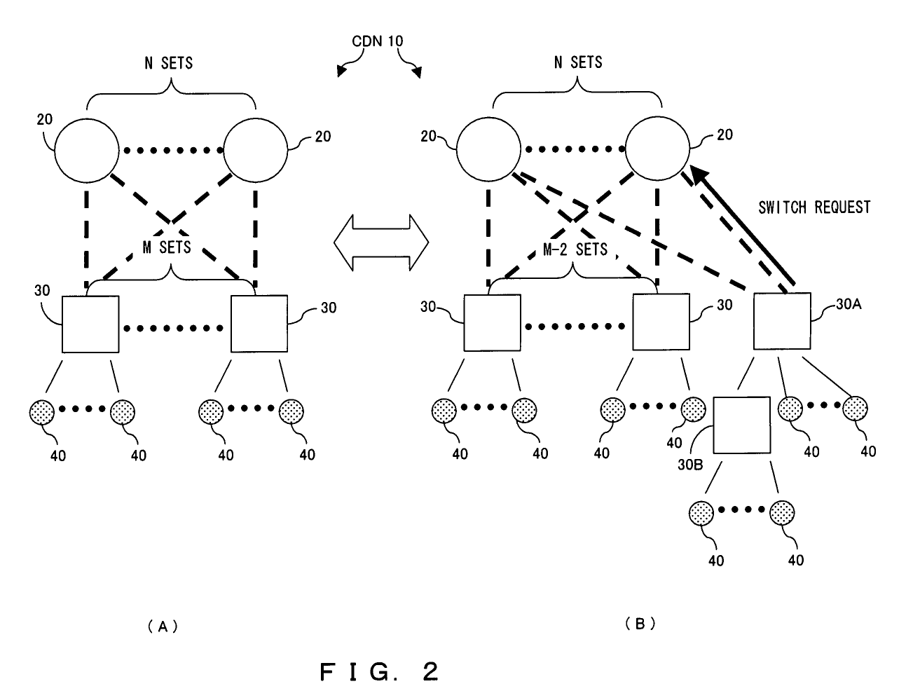

FIG. 2 shows the summary of the present invention.

In (A) of FIG. 2, a CDN 10 is comprised of n contents servers 20, m cache servers 30 and a plurality of clients 40. The contents servers 20 sit at the top, the cache servers 30 are subordinately connected to the contents servers 20, and the clients 40 are subordinately connected to the cache servers 30. AS shown in (B) of FIG. 2, the CDN 10 can also adopt another network configuration in which another cache server 30B is subordinately connected to a specific cache server 30A.

For example, if as shown in (B) of FIG. 2, the load of cache server 30A is heavy since the cache server 30B is subordinately connected to the cache server 30A, the cache server 30A requests the higher-order contents server 20 to switch the connection of the cache server 30B, which is its load source. Then, the contents server 20 search for the connection destination of the cache server 30B, and the network configuration shown in (A) of FIG. 2 can be obtained. Conversely, the network configuration can also be obtained. Thus, the network configurations can be modified each other between the CDN 10 shown in (A) of FIG. 2 and the CDN 10 shown in (B) of FIG. 2.

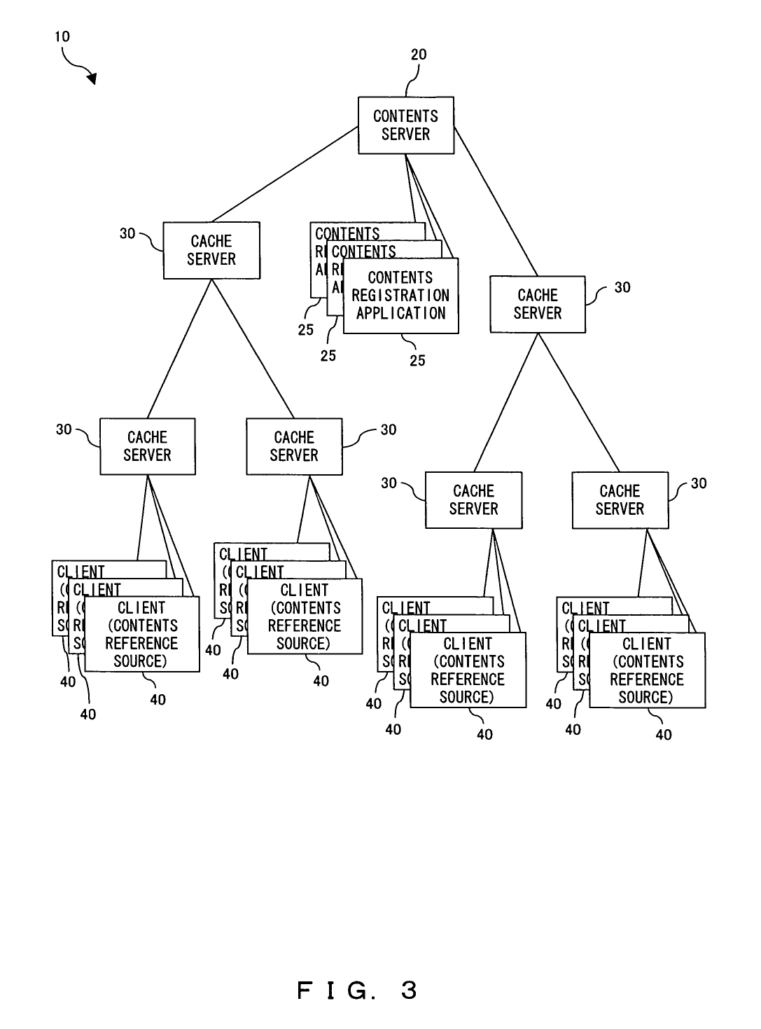

FIG. 3 shows an example of the network configuration adopting the present invention.

In FIG. 3, a contents delivery network (CDN) 10 comprises a contents server 20 with contents, a cache server 30 for caching at least a part of the contents of the contents server 20, a client (contents reference source) 40 for referring to the contents of the contents server 20 and a contents registration application 25 for registering contents in the contents server 20 and updating the contents. The client 40 has the conventional general functions. The contents registration application 25 can also be mounted on the contents server 20 itself. In that case, the contents are internally registered and updated.

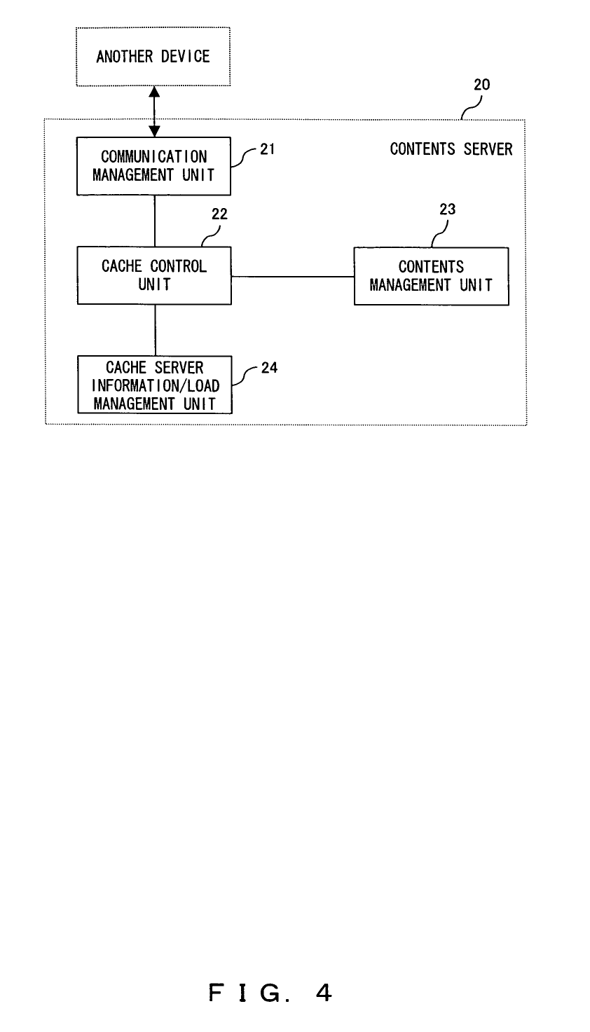

FIG. 4 shows an example of the functional configuration of a contents sever.

In FIG. 4, the contents server comprises a communication management unit 21, a cache control unit 22, a contents management unit 23 and a cache server information/load management unit 24.

The communication management unit 21 receives communication addressed from another device, such as a cache server 30 or the like, to the contents server 20 and distributes requests to each necessary unit, according to its process contents. For example, when receiving a cache-related message, the communication management unit 21 transfers the received contents to the cache control unit 22. When there is a request for modifying a connection destination, from the cache server 30, the communication management unit 21 searches for another connectable cache server 30 and transmits a connection destination modification request to the other cache server 30. The communication management unit 21 also receives requests from each unit and transmits a message corresponding to the request to another device. For example, the communication management unit 21 transmits a message for requesting for cache update to a cache server 30.

The cache control unit 22 determines necessary processes in each case, using a request from each unit as a trigger and distributes the processes to each unit. The contents management unit 23 stores and manages contents to cache. The cache server information/load management unit 24 stores and manages the cache server information of the cache server 30 caching the contents, and manages a load due to the provision of files.

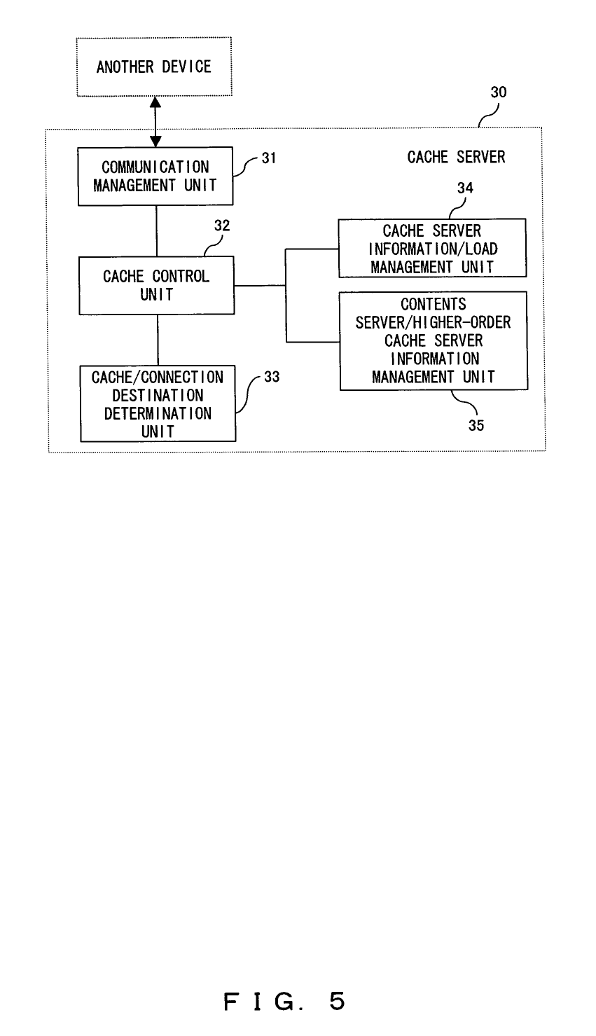

FIG. 5 shows an example of the functional configuration of the cache server.

In FIG. 5, the cache server 30 comprises a communication management unit 31, a cache control unit 32, a cache/connection destination determination unit 33, a cache information/load management unit 34 and a contents server/higher-order cache server information management unit 35.

The communication management unit 31 receives communication addressed from another device, such as a contents server 20, another cache server 30 or the like, to the cache server 30 and distributes requests to each necessary unit, according to its process contents. For example, when receiving a cache-related message, the communication management unit 31 transfers the received requests to the cache control unit 32. The communication management unit 31 also receives requests from each unit and transmits a message corresponding to the request to another device. For example, the communication management unit 21 transmits a message for requesting for cache update to a contents server 20 or another cache server 30 or a message for requesting a contents server 20 to switch the connection destination of a cache server 30 in which its own cache is obtained.

The cache control unit 32 determines necessary processes in each case, using a request from each unit as a trigger and distributes the processes to each unit. The cache/connection destination determination unit 33 determines or modifies contents to cache, its connection destination (acquisition destination) and its attribute, according to a request from a client 40 or another cache server 30. The cache information/load management unit 34 stores and manages the cache server information of contents to cache and a client 40 or another cache server 30 requesting the contents, monitors its own load by managing a load due to the provision of files and instructs a part of another cache server 30 regularly obtaining its own cache to go to another cache server 30 to obtain it if the load is heavy.

The contents server/higher-order cache server information management unit 35 stores and manages the cache server information of contents to cache and a contents server 20 with its original or the higher-order cache server 30, which is its contents acquisition destination, further stores and manages the cache server information of the connection destination cache server 30 if the contents acquisition destination is a higher-order cache server 30.

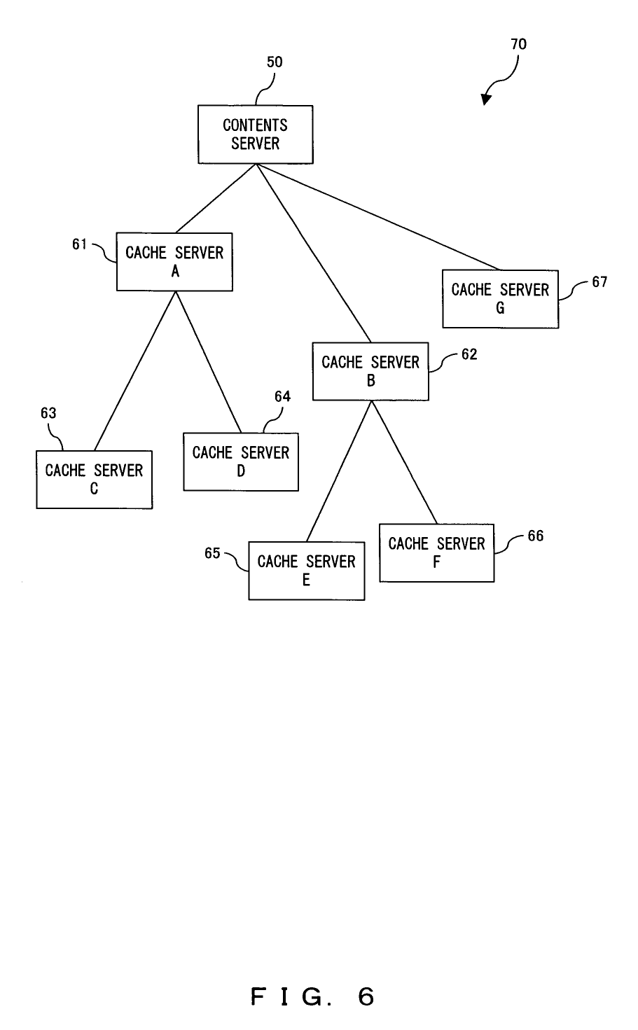

Next, an example of the operation of the contents delivery network (CDN) of the present invention is described with reference to FIGS. 6 through 26.

FIG. 6 shows a contents delivery network for showing an example of the operation of the present invention.

In FIG. 6, in a contents delivery network (CDN) 70, using a contents server 50 as a root (the first layer), cache servers A 61, B 62 and G 67 are immediately subordinately connected to the contents 50 (in the second layer), cache servers C 63 and D 64 are immediately subordinately connected to the cache server A 61 (in the third layer) and cache servers E 65 and F 66 are immediately subordinately connected to the cache server B 62 (in the third layer). To each of these cache servers A 61 through G 67, usually several clients, which are not shown in FIG. 6, are connected.

These cache servers A 61 through G 67 cache contents in the contents server 50 and deliver the contents a client according to a request from the client. Then, each of these cache servers A 61 through G 67 comprises a load measuring unit, an overflown load determination unit, a connection destination retrieval request information transmitting unit, a connection destination information receiving unit and a switch request transmitting unit.

The load measuring unit measures, for example, the load of the cache server A 61 by the cache server C 63 subordinately connected to the cache server 61A caching contents cached in the cache server A 61. The overflown load determination unit determines whether the load is overflown, by comparing the load measured by the load measuring unit with a predetermined value.

In this case, the load of the cache server A 61 can also be measured based on the size of the contents of the cache server C 63, which is its load source, requested to access. Alternatively, the load can be measured based on the number of clients requesting to access the cache server C 63. Alternatively, the load can be measured based on the frequency of accesses to the cache server C 63. Alternatively, the load can be measured based on the overlapped degree of contents between the contents to be cached by the cache server A 61 and the contents to be cached by the cache servers C 63 and D 64. The measurement based on this overlapped degree is used for the reason that there is no meaning in the existence of the cache server C 63, for example, if only the cache server C 63 is subordinately connected to the cache server A 61 and also if the contents to be cached by the cache server A 61 and the contents to be cached by the cache server C 63 are the same, specifically the respective contents to be cached by the cache server A 61 and C 63 one of which is subordinate to the other, overlap.

The connection destination retrieval request information transmitting unit transmits connection destination retrieval request information for requesting to search for the connection destination of the cache server C 63 which is its load source to the contents server 50 or another cache server D 74 when the overflown load determination unit determines that the load is overflown. In this case, the information is transmitted to the contents server 50 or another cache server D 64 in predetermined order. For example, the connection destination retrieval request information is first transmitted to the contents server 50 which is positioned in the higher order of the hierarchically structures contents delivery network (CDN) 70. When transmitting the connection destination retrieval request information, information about the cache server C 63 which is its load source, can also be transmitted together with the connection destination retrieval request information.

Then, the connection destination information receiving unit receives connection destination information indicating the connection destination retrieved by the contents server 50, such as information indicating that it can be connected to the cache server B 62, from the transmitting destination contents server 50 to which the connection destination retrieval request information transmitting unit has transmitted the connection destination retrieval request information. The switch request transmitting unit transmits switch request information for requesting to switch the connection to a connection destination indicated in the connection destination information (cache server B 62) to the cache server C 63, based on the connection destination information received by the connection destination information receiving unit.

Then, the cache server C 63 switches the connection destination from the cache server A 61 to the cache server B 62.

The contents server 50 comprises a connection destination retrieval request information receiving unit, a connection destination retrieval request information transfer unit, a connection destination possible/impossible determination result receiving unit, a connection destination determination unit and a connection destination possible/impossible determination result transmitting unit.

The connection destination retrieval request information receiving unit receives connection destination retrieval request information for requesting to search for the connection destination of the cache server C 63 which is its load source, from the cache server A 61. The connection destination retrieval request information transfer unit transfers the connection destination retrieval request information received by the connection destination retrieval request information receiving unit to another cache server B 62 subordinately connected to the contents server 50.

The connection destination possible/impossible determination result receiving unit receives connection destination possible/impossible determination result indicating whether the server can be the connection destination of the cache server C 63, from the other cache server B 62 to which the connection destination retrieval request information is transferred. The connection destination determination unit determines whether the server can be the connection destination of the load source cache server, based on the load of the server if none of the connection destination possible/impossible determination results received by the connection destination possible/impossible determination result receiving unit can be the connection destination of the cache server C 63.

The connection destination possible/impossible determination result transmitting unit transmits connection destination possible/impossible determination result indicating whether the connection destination determined by the connection destination determination unit is possible, to the cache server.

The other cache server B 62 requested to search for the connection destination by the contents server 50 comprises a connection destination retrieval request information receiving unit, a connection destination determination unit, a connection destination retrieval request information transfer unit and a connection destination possible/impossible determination result transmitting unit.

The connection destination retrieval request information receiving unit receives connection destination retrieval request information for requesting to search for the connection destination of the cache server C 63 which is the load source of the cache server A 61 from the contents server 50. The connection destination determination unit determines whether the server can be the connection destination of the cache server C 63, based on the own load of the cache server B 62 included in the connection destination retrieval request information received by the connection destination retrieval request information receiving unit. In this case, the own load of the cache server B 62 is basically measured by the same standard as the cache server A 61, and by determining whether its load is overflown if the cache server C 63 is connected to the server, it is determined whether the server could be the connection destination.

The connection destination retrieval request information transfer unit transfers connection destination retrieval request information to another cache server E 65 or F 66 which are subordinately connected to the cache server B 62 in predetermined order if the connection destination possible/impossible determination result indicating whether the connection destination determined by the connection destination determination unit can be possible as the connection destination of the cache server C 63 (it is determined that its load is overflown if the cache server C 63 is connected to the server.

Then, the connection destination possible/impossible determination result transmitting unit transmits the connection destination possible/impossible determination result indicating whether the connection destination determined by the connection destination determination unit is possible, to the contents server 50 that has transmitted the connection destination retrieval request information.

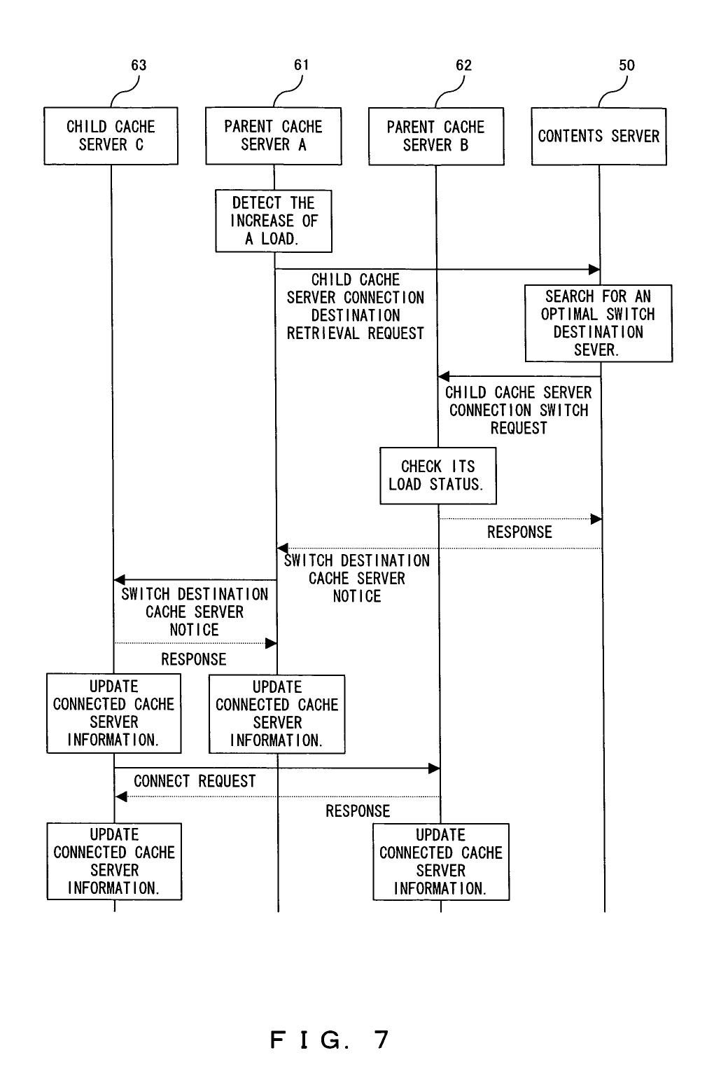

FIG. 7 shows an example of the operation of switching the connection destination of a two-layer lower cache server to another cache server, due to the load increase of the highest-order cache server.

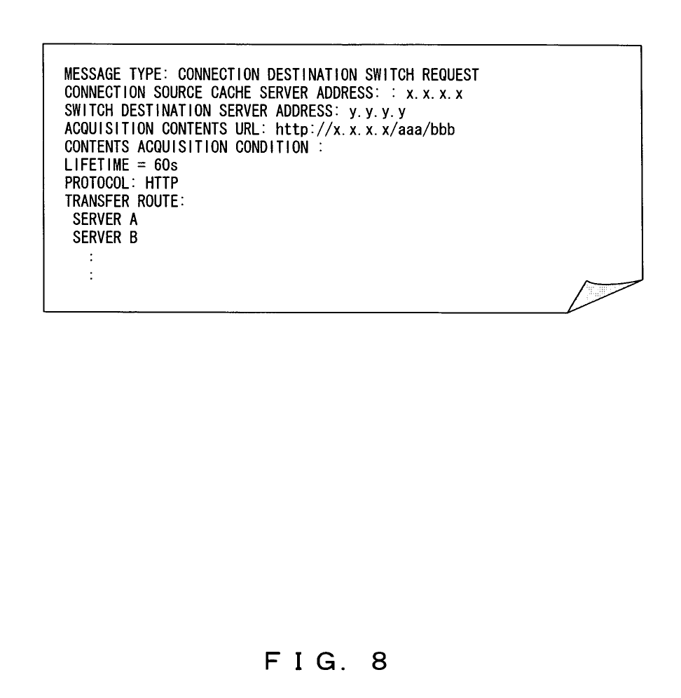

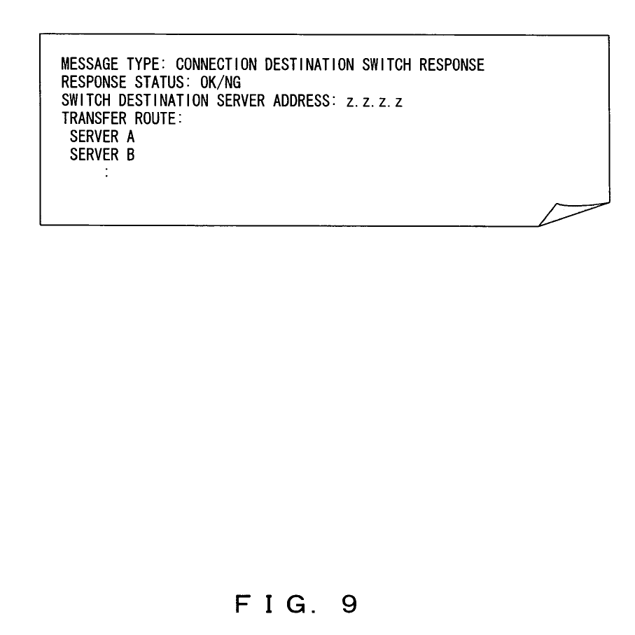

FIG. 8 shows an example of information included in a connection destination switch request message. FIG. 9 shows an example of information included in a connection destination switch response message. These messages are transmitted/received when a cache server or contents server which searches for a switch destination inquires whether the server can be connected to a switch destination candidate.

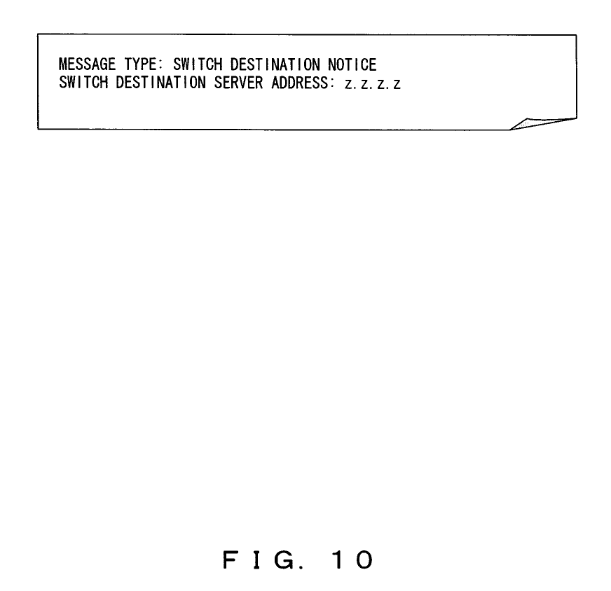

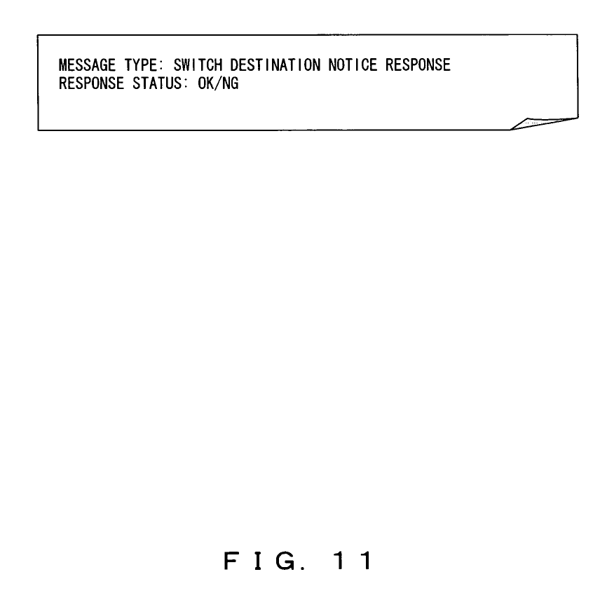

FIG. 10 shows an example of information included in a switch destination notice message. FIG. 11 shows an example of information included in a switch destination response message. These messages are transmitted/received when a cache server or contents server conveys the information to a cache server to which the connection is determined to be switched.

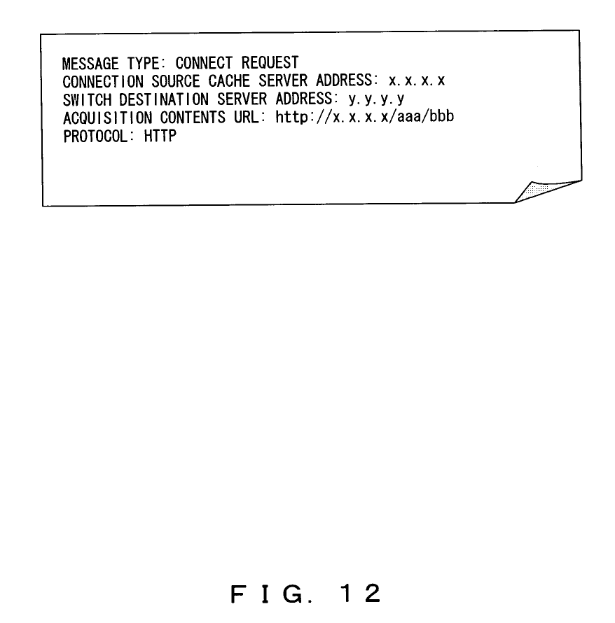

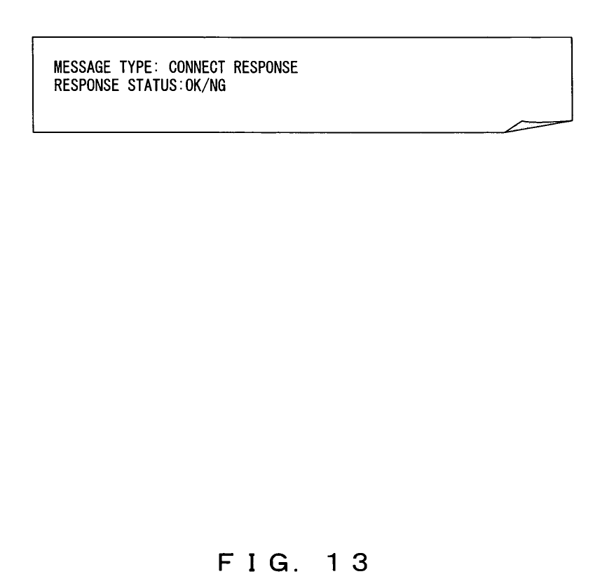

FIG. 12 shows an example of information included in a connection request message. FIG. 13 shows an example of information included in a connection response message. These messages are transmitted/received when a cache server notified of the switch destination is connected to the switch destination.

Firstly, when detecting the increase of its own load, the parent cache server A 61 (the highest-order cache server) transmits a request for searching for the connection destination of a child cache server C 63 which is its load source, to the contents server 50 to which the cache server A 61 is subordinately connected. In this case, the request is modified to a request for contents update under the lead of the cache server, if necessary.

Then, the contents server 50 searches for the optimal switch destination cache server of the child cache server C 63 among the cache servers connected to the contents server 50 itself. In this case, the cache server B 62 is retrieved as the switch destination by the determination method described with reference to FIG. 6, and a child cache server connection switch request (see FIG. 8) is transmitted to the cache server B 62.

Then, the parent cache server B 62 (the highest-order cache server) selected as the connection destination checks its own load status, and if the connection is possible, its response is returned to the contents server 50 (see FIG. 9).

Then, upon receipt of the response, the contents server 50 transmits information about the switch destination parent cache server B 62 (see FIG. 10) to the parent cache server A 61.

Then, the parent cache server A 61 transmits the information about the switch destination parent cache server B 62 (see FIG. 10) to a child cache server C 63.

Then, the child cache server C 63 returns its response (see FIG. 11) to the parent cache server A 61 and updates its own connected cache server information of the cache server C 63. The child cache server C 63 also transmits a connect request (see FIG. 12) to the parent cache server B 62.

Then, upon receipt of the response (see FIG. 11), the parent cache server A 61 updates its own connected cache server information.

Then, upon receipt of the connect request (see FIG. 12), the parent cache server B 62 returns its response (see FIG. 13) and updates it own connected cache server information.

Lastly, after receiving the response (see FIG. 13), the child cache server C 63 updates its own connected cache server information of the cache server C 63.

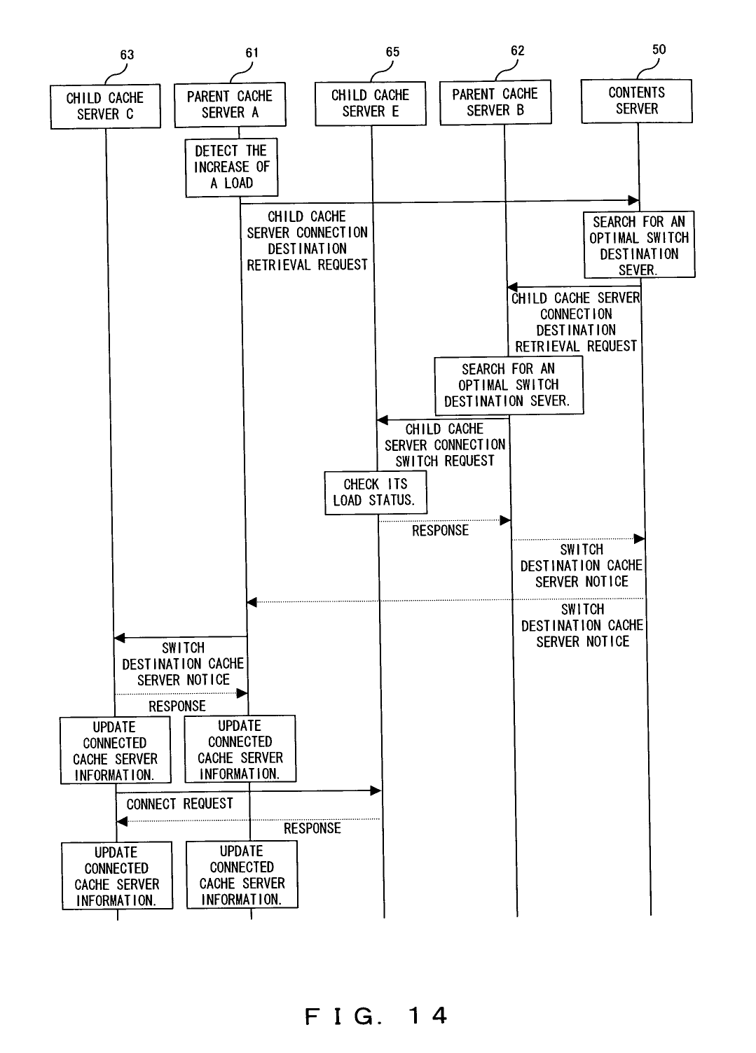

FIG. 14 shows an example of the operation of switching the connection destination of a two-layer lower cache server to another two-layer lower cache server, due to the load increase of the highest-order cache server.

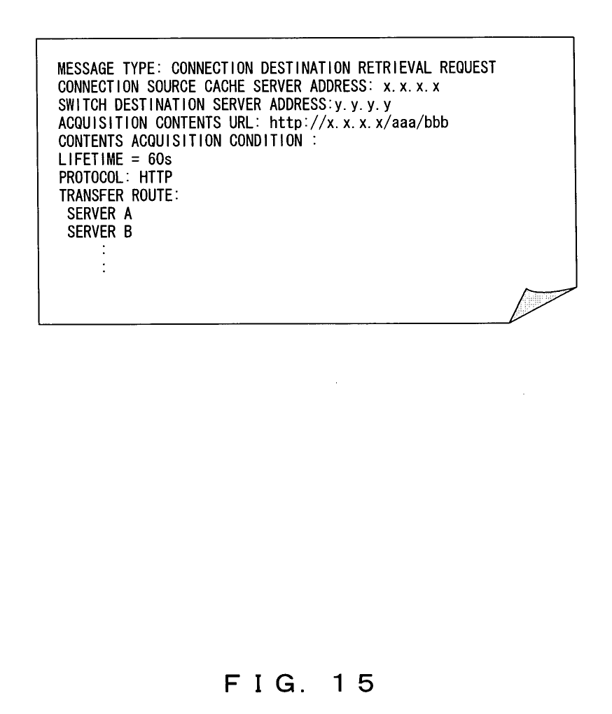

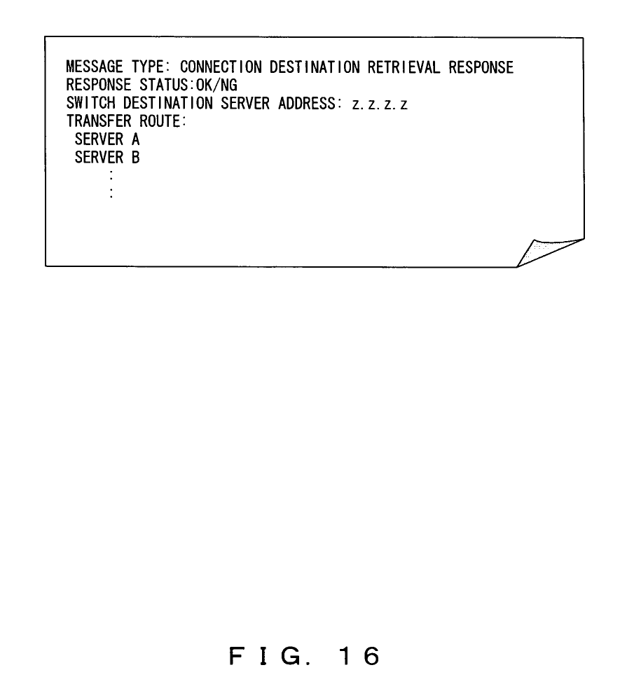

FIG. 15 shows an example of information included in a connection destination retrieval request message. FIG. 16 shows an example of information included in a connection destination retrieval response message. These messages are transmitted/received when a cache server or contents server that searches for a switch destination inquires a switch destination of another server.

Firstly, when detecting the increase of its own load, the parent cache server A 61 (the highest-order cache server) in FIG. 14 transmits a request for searching for the connection destination of a child cache server C 63 which is its load source, to the contents server 50 to which the cache server A 61 is subordinately connected. In this case, the request is modified to a request for contents update under the lead of the cache server, if necessary.

Then, the contents server 50 searches for the optimal switch destination cache server of the child cache server C 63 among the cache servers connected to the contents server 50 itself. In this case, an optimal switch destination cache server cannot be retrieved by the determination method described with reference to FIG. 6.

Therefore, the contents server 50 searches for the optimal switch destination cache server of the child cache server C 63 among the cache servers connected to the cache server B 62 subordinately connected to the contents server 50. In this case, the cache server E 65 is retrieved as the switch destination by the determination method described with reference to FIG. 6, and the child cache server connection switch request (see FIG. 15) is transferred to the cache server E 65.

Then, upon receipt of the child cache server connection switch request, the cache server E 65 checks its own load status and if the connection is possible, it returns its response to the parent cache server B 62 (see FIG. 16).

Then, upon receipt of the response, the parent cache server B 62 transmits a switch destination cache server notice (information about the child cache server E 65) to the contents server 50.

Then, the contents server 50 transmits a switch destination cache server notice (information about the child cache server E 65) to the parent cache server A 61 (see FIG. 10).

Then, the parent cache server A 61 transmits information about the switch destination child cache server E 65 (see FIG. 10) to the cache server C 63.

Then, the cache server C 63 returns its response (see FIG. 11) to the parent cache server A 61 and updates its own connected cache server information. The cache server C 63 transmits a connect request (see FIG. 12) to the child cache server E 65.

Then, upon receipt of the response, the parent cache server A 61 updates its own connected cache server information.

Then, upon receipt of the connect request (see FIG. 12), the parent cache server E 65 returns its response (see FIG. 13) and updates its own connected cache server information.

Lastly, after receiving the response (see FIG. 13), the child cache server C 63 updates its own connected cache server information.

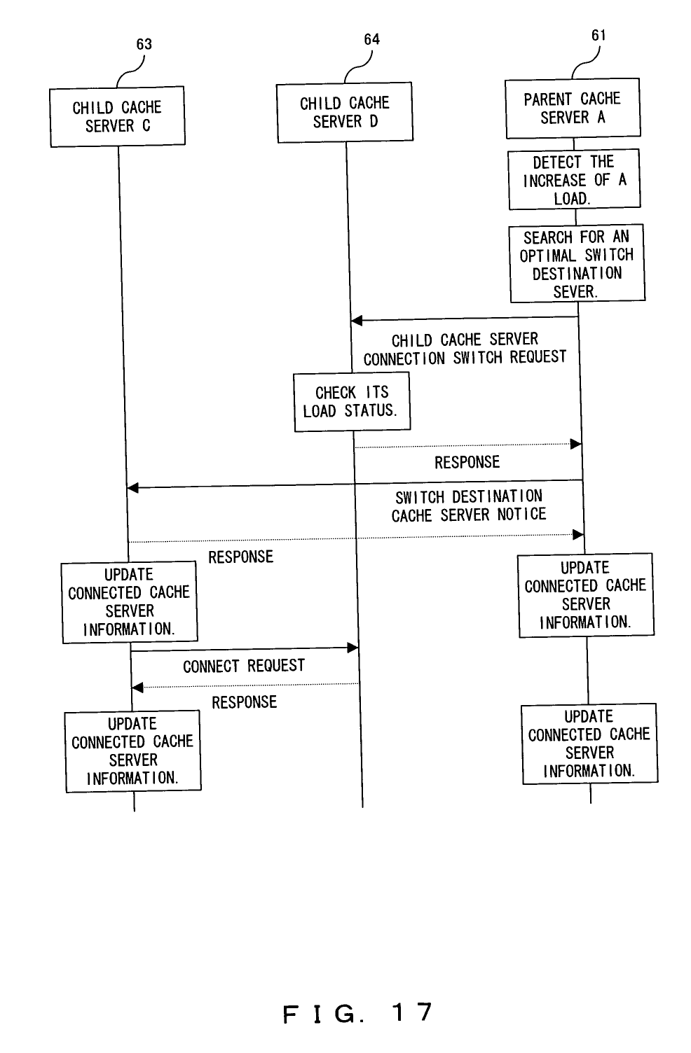

FIG. 17 shows another example of the operation of switching the connection destination of a two-layer lower cache server to another two-layer lower cache server, due to the load increase of the highest-order cache server.

Firstly, when detecting the increase of its own load, the parent cache server A 61 (the highest-order cache server) searches for the optimal switch destination cache server of the child cache server C 63 among the cache servers connected to the cache server A 61 itself. In this case, an optimal switch destination cache server cannot be retrieved by the determination method described with reference to FIG. 6.

Therefore, the contents server 50 searches for the optimal switch destination cache server of the child cache server C 63 among the cache servers connected to the cache server B 62 subordinately connected to the contents server 50. In this case, the cache server D 64 is retrieved and the cache server A 61 transmits a child cache server connection switch request (see FIG. 8) to the cache server D 64.In this case, the request is modified to a request for contents update under the lead of the cache server.

Then, the child cache server D 64 selected as the connection destination receives the child cache server connection switch request (see FIG. 8), checks its own load status and if the connection is possible, it returns its response (see FIG. 9) to the parent cache server A 61.

Then, upon receipt of the response, the parent cache server A 61 transmits a switch destination cache server notice (information about the child cache server D 64) to the child cache server C 63 which is the load source of the cache server A 61 (see FIG. 10).

Then, the cache server C 63 returns its response (see FIG. 11) to the parent cache server A 61 and updates its own connected cache server information. The cache server C 63 transmits a connect request to the child cache server D 64 (see FIG. 12).

Then, upon receipt of the response, the parent cache server A 61 updates its own connected cache server information.

Then, upon receipt of the connect request, the child cache server D 64 returns its response (see FIG. 13) and updates its own connected cache server information.

Lastly, after receiving the response, the child cache server C 63 updates its own connected cache server information.

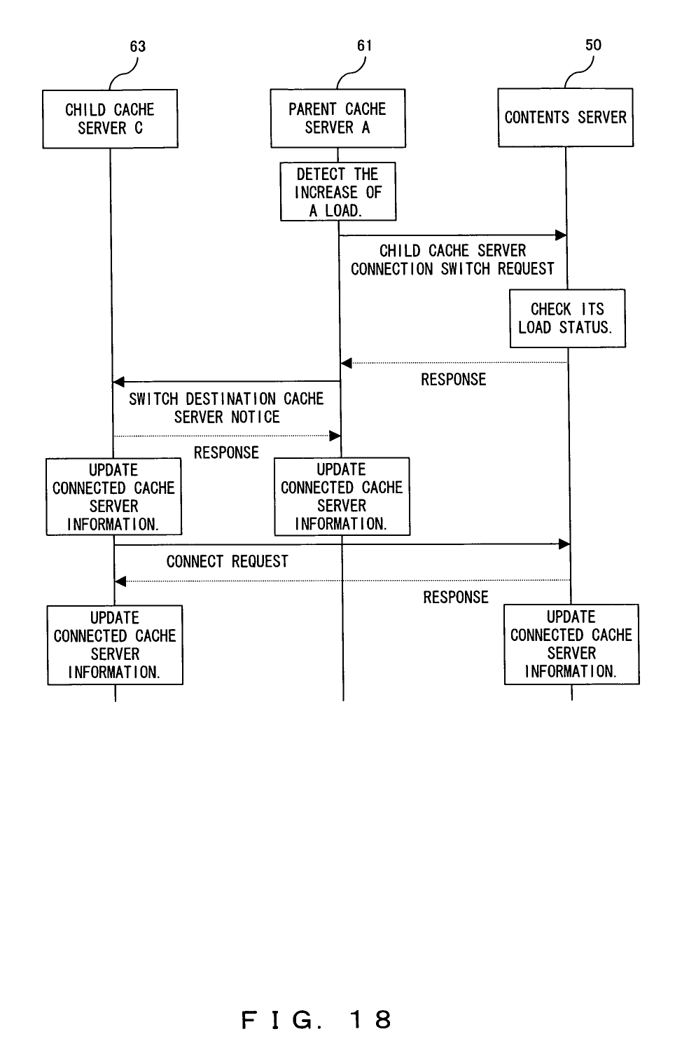

FIG. 18 shows an example of the operation of switching the connection destination of a two-layer lower cache server to a contents sever, due to the load increase of the highest-order cache server.

Firstly, when detecting the increase of its load, the parent cache server A 61 (the highest-order cache server) transmits a child cache server connection switch request to a contents 50. In this case, the request is modified to a request for contents update under the lead of the cache server, if necessary.

Then, the contents server 50 refers to its own load and if the connection is possible, it notifies to the parent cache server A 61 of the fact.

Then, the parent cache server A 61 transmits a switch destination cache server notice (information about the contents server 50) to the child cache server C 63.

Then, the child cache server C 63 returns its response to the parent cache server A 61 and updates its own connected cache server information. The child cache server C 63 transmits a connect request to the contents server 50.

Then, upon receipt of the response, the parent cache server A 61 updates its own connected cache server information.

Then, upon receipt of the connect request, the contents server 50 returns its response and updates its own connected cache server information.

Lastly, after receiving the response, the child cache server C 63 updates its own connected cache server information.

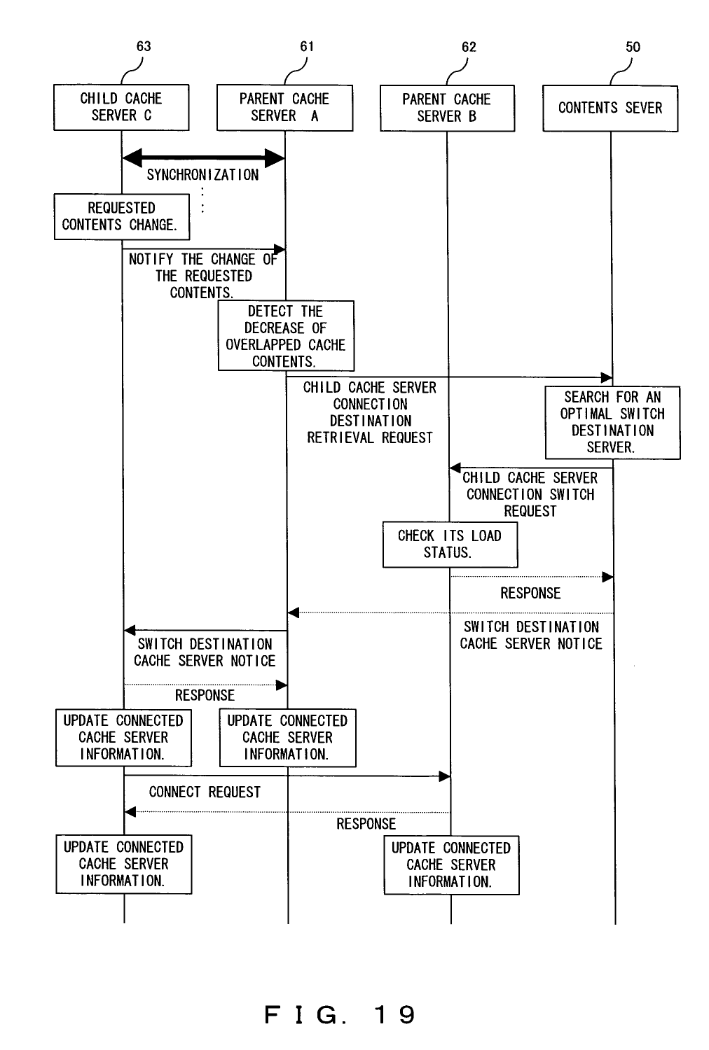

FIG. 19 shows an example of the operation in the case where the connection is switched, due to the decrease of overlapped cache contents between a parent cache server and a child cache server.

Firstly, the child cache server C 63 and the parent cache server A 61 regularly synchronize their cached contents with each other.

Then, the child cache server C 63 notifies the parent cache server A 61 of the requested contents.

Then, when detecting the decrease of its contents overlapped with the child cache server C 63 and cached, the parent cache server A 61 transmits a child cache server connection destination retrieval request to a contents server 50.

Then, the contents server 50 searches for the optimal switch destination cache server of the child cache server C 63 among cache servers connected to the contents server 50 itself and transmits the child cache server connection destination retrieval request to the retrieved cache server B 62.

Then, the parent cache server B 62 selected as the switch destination checks its own load status and if the connection is possible, it transmits its response to the contents server 50.

Then, upon receipt of the response, the contents server 50 transmits a switch destination cache server notice (information about the parent cache server B 62) to the parent cache server A 61.

Then, the parent cache server A 61 transmits the switch destination cache server notice to the child cache server C 63.

Then, the child cache server C 63 returns its response to the parent cache server A 61 and updates its own connected cache server information. The child cache server C 63 also transmits a connect request to the parent cache server B 62.

Then, upon receipt of the response, the parent cache server A 61 updates its own connected cache server information.

Then, upon receipt of the connect request, the parent cache server B 62 returns its response and updates its own connected cache server information.

Lastly, after receiving the response, the child cache server C 63 updates its own connected cache server information.

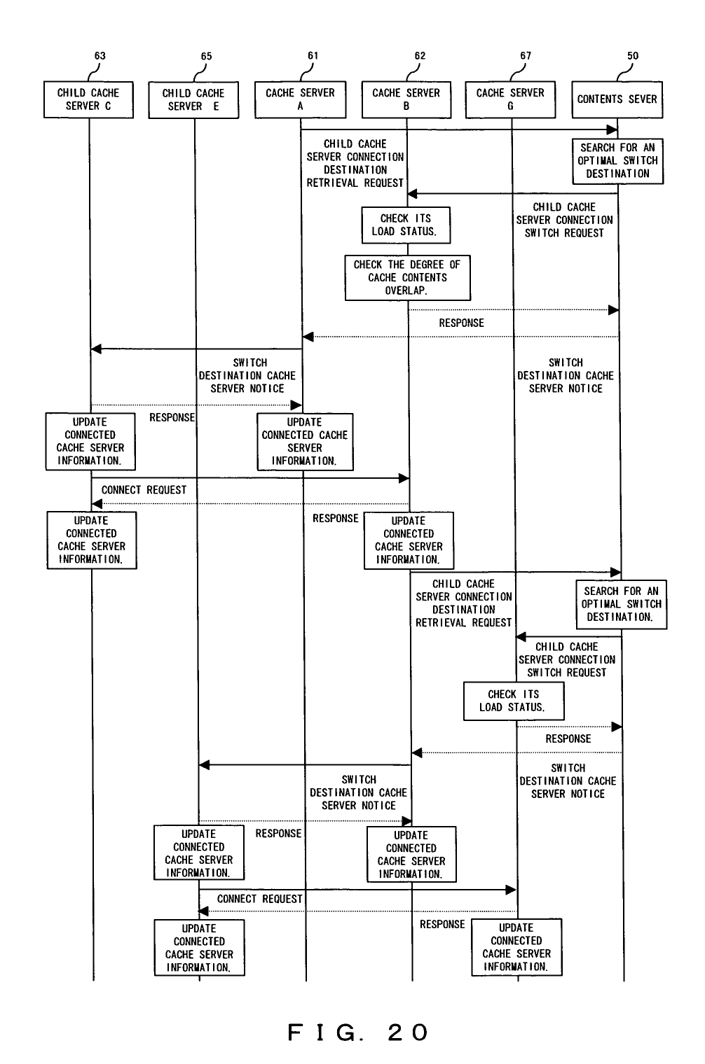

FIG. 20 shows an example of the operation in the case where a request for switching a connection to a cache server in which overlapped contents to cache is large is received from a contents sever.

Firstly, the parent cache server A 61 transmits a child cache server connection destination retrieval request to the contents server 50.

Then, the contents server 50 searches for the optimal switch destination cache server of a child cache server C 63 among cache servers connected to the contents server 50 itself and transmits the child cache server connection destination retrieval request to the retrieved cache server B 62.

Then, the parent cache server B 62 selected as the switch destination checks its own load status. In this case, if overlapped contents cached with the child cache server C 63 requested to connect is large even when its load is heavy, the parent cache server B 62 is connected to this child cache server C 63 and a child cache server E 65 in which overlapped cached contents is small is replaced with the child cache server C 63. Therefore, the parent cache server B 62 returns its response to the contents server 50.

Then, upon receipt of the response, the contents server 50 transmits a switch destination cache server notice (information about the parent cache server B 62) to the parent cache server A 61.

Then, the parent cache server A 61 transmits the switch destination cache server notice (information about the parent cache server B 62) to the child cache server C 63.

Then, the child cache server C 63 returns its response to the parent cache server A 61 and updates its own connected cache server information. The child cache server C 63 also transmits a connect request to the parent cache server B 62.

Then, upon receipt of the response, the parent cache server A 61 updates its own connected cache server information.

Then, upon receipt of the connect request, the parent cache server B 62 returns its response and updates its own connected cache server information.

Then, after receiving the response, the child cache server C 63 updates its own connected cache server information.

Then, since the load of the parent cache server B 62 increases, the parent cache server B 62 transmits a child cache server connection destination retrieval request to the contents server 50.

Then, the contents server 50 searches for the optimal switch destination of the child cache server E 65 among cache servers connected to the contents server 50, and a transmits the child cache server connection destination retrieval request to the retrieved cache server G 67.

Then, the parent cache server G 67 selected as the switch destination checks its own load status and if the connection is possible, it transmits its response to the contents server 50.

Then, upon receipt of the response, the contents server 50 transmits a switch destination cache server notice (information about the cache server G 67) to the parent cache server B 62.

Then, the parent cache B 62 transmits the switch destination cache server notice (information about the cache server G 67) to the child cache server E 65.

Then, the cache server E 65 returns its response to the parent cache server B 62 and updates its own connected cache server information. The cache server E 65 also transmits a connect request to the parent cache sever G 67.

Then, upon receipt of the response, the parent cache server B 62 updates its own connected cache server information.

Then, upon receipt of the connect request, the parent cache server G 67 returns its response and updates its own connected cache server information.

Lastly, after receiving the response, the child cache server E 65 updates its own connected cache server information.

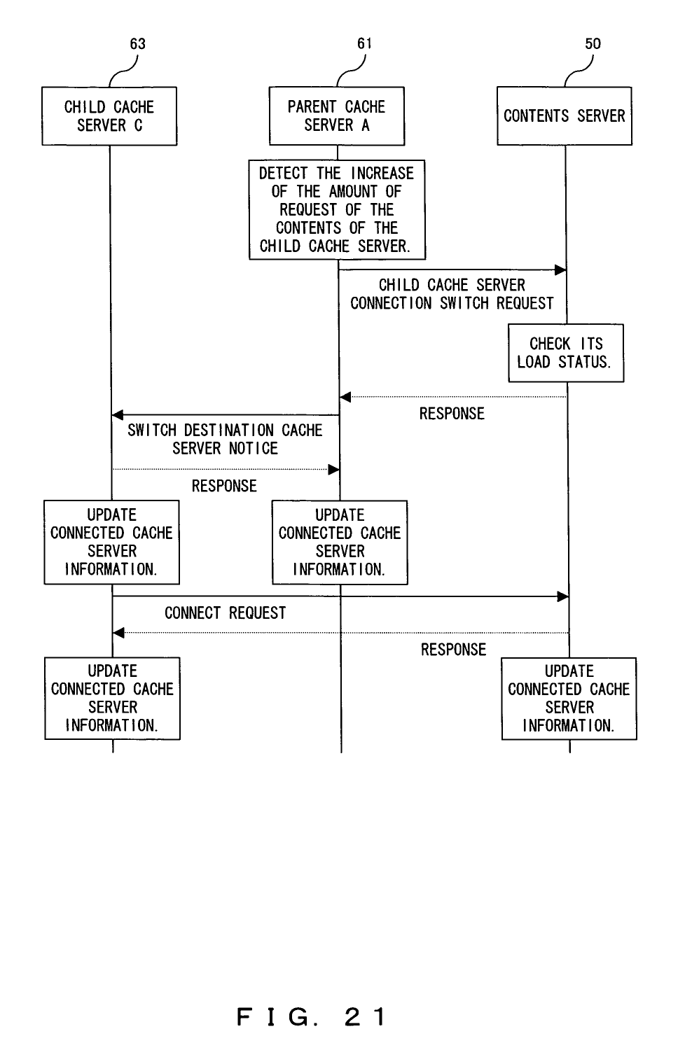

FIG. 21 shows an example of the connection destination switching operation in the case where the amount of contents requested by a child cache server relatively increases and the child cache server is directly connected to a contents sever.

Firstly, when contents requested by the child cache server C 63 increase or contents requested by the parent cache server A 61 decrease, the parent cache server A 61 detects the relative increase in the requested amount of the child cache server C 63.

Then, the parent cache server A 61 transmits a child cache server connection request to the contents server 50 so as to directly connect the child cache server C 63, the increase of whose contents is detected, to the contents server 50.

Then, the contents server 50 checks its own load status and if the child cache server C 63 is possible, it returns its response to the parent cache server A 61.

Then, the parent cache server A 61 transmits a connection destination server switch request to the child cache server C 63 so as to connect the child cache server C 63 to the contents server 50.

Then, the child cache server C 63 returns its response to the parent cache server A 61 and also updates its own connected cache server information. Furthermore, the child cache server C 63 transmits a connect request to the contents server 50.

Then, upon receipt of the connect request, the contents server 50 returns its response to the child cache server C 63 and also updates its own connected cache server information.

Lastly, upon receipt of the response, the child cache server C 63 updates its own connected cache server information.

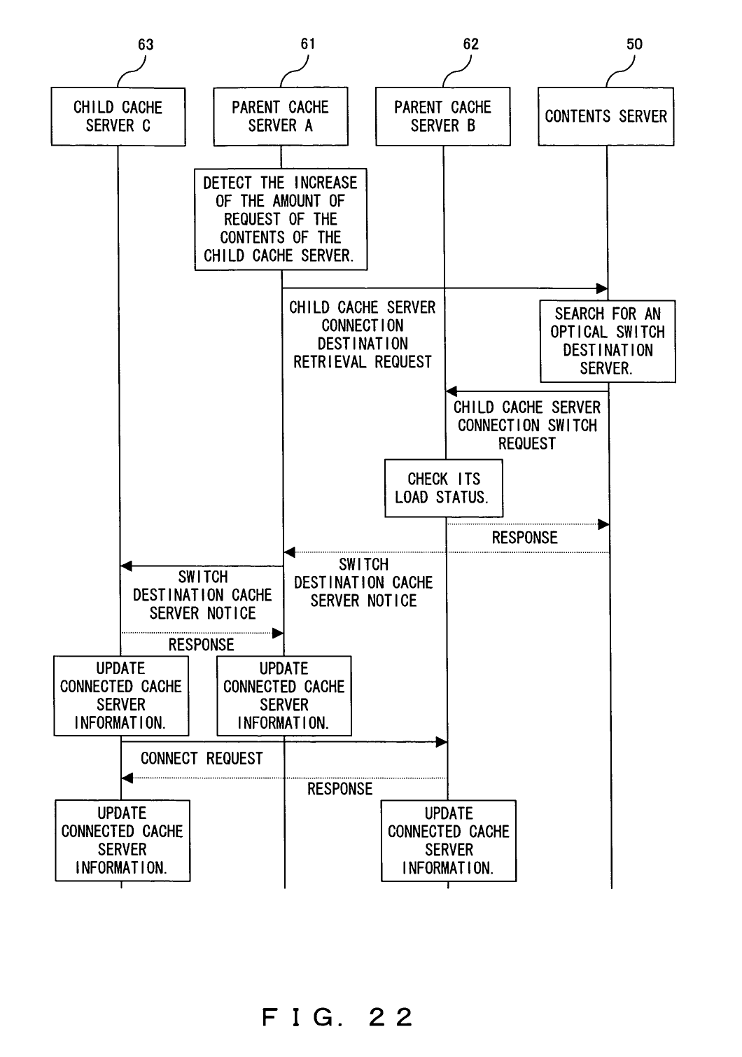

FIG. 22 shows an example of the connection destination switching operation in the case where the amount of contents requested by a child cache server relatively increases and the connection of the child cache server is switched to another cache server.

Firstly, when contents requested by the child cache server C 63 increase or contents requested by a parent cache server A 61 decrease, the parent cache server A 61 detects the relative increase in the requested amount of the child cache server C 63.

Then, the parent cache server A 61 transmits a child cache server switch request to the contents server 50.

Then, the contents server 50 searches for the optimal switch destination of the child cache server C 63 among cache servers connected to the contents server 50 itself, and transmits a child cache connection request to the retrieved cache server B 62.

Then, the parent cache server B 62 selected as the connection destination checks its own load status, and if the connection is possible, it returns its response to the contents server 50.

Then, upon receipt of the response, the contents server 50 transmits information about the parent cache server B 62 to the child cache server C 63.

Then, the child cache server C 63 returns its response to the parent cache server A 61 and updates its own connected cache server information. The child cache server C 63 also transmits a connect request to the parent cache server B 62.

Then, upon receipt of the response, the parent cache server A 61 updates its own connected cache server information.

Then, upon receipt of the connect request, the parent cache server B 62 returns its response and updates its own connected cache server information.

Lastly, after receiving the response, the child cache server C 63 updates its own connected cache server information.

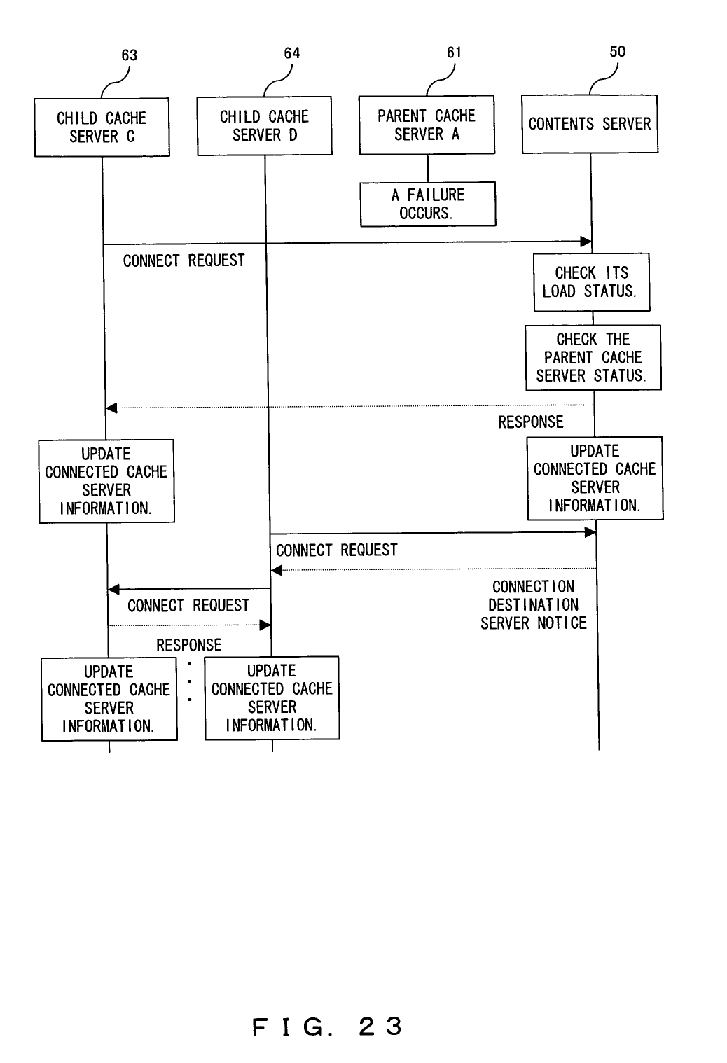

FIG. 23 shows an example of the operation in the case where a failure occurs in a parent cache server and the connection destination of the cache server is modified.

Firstly, the parent cache server A 61 fails and stops.

Then, each of all child cache servers C 63 and D 63 which are connected to the stopped parent cache server A 61 transmits a connect request to the contents server 50.

Then, when receiving the first connect request (for example, the connect request from the cache server C 63), the contents server 50 checks its own load status, and also checks the status of the parent cache server A 61. Due to the stoppage of the parent cache server A 61, the contents server 50 returns its response to the child cache server C 63 and updates its own connected cache server information.

Then, upon receipt of the response, the child cache server C 63 updates its own connected cache server information.

Then, the contents server 50 notifies the information about the child cache server C 63 first connected as the connection destination server in response to connect requests received after that (connect request from the cache server D 64).

Then, upon receipt of the notice, the child cache server D 64 transmits a connect request to the child cache server C 63.

Then, upon receipt of the connect request, the child cache server C 63 returns its response and updates its own connected cache server information.

Lastly, upon receipt of the response, the child cache server D 64 updates its own connected cache server information.

If there are other child cache servers, the same process is applied to all the other child cache servers.

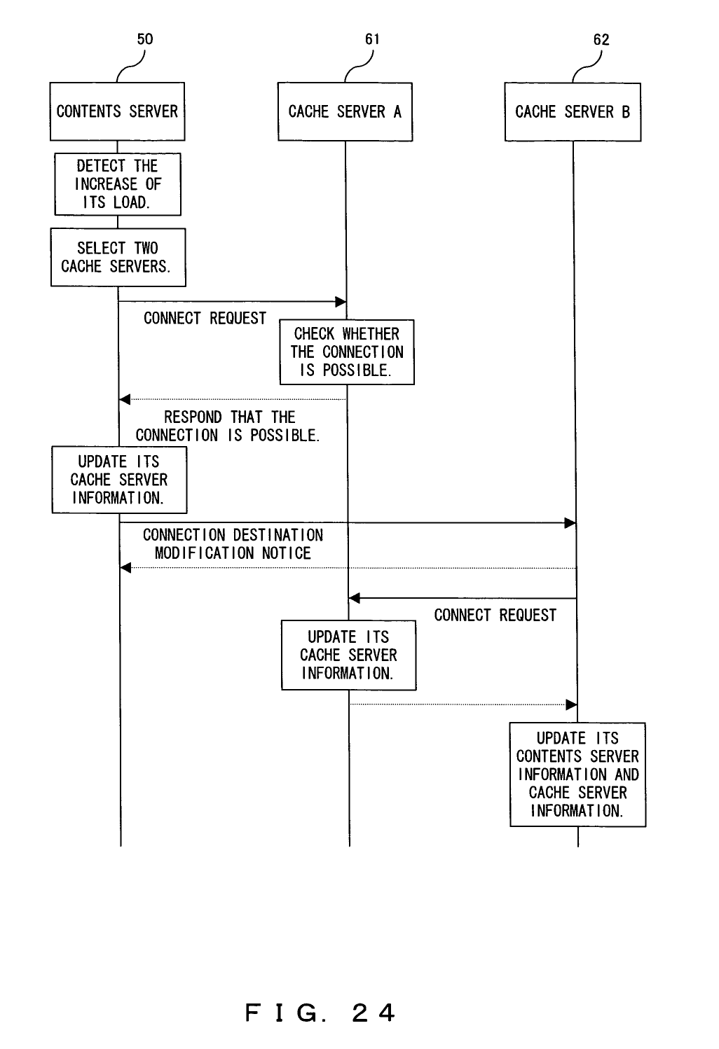

FIG. 24 shows an example of the operation of switching the connection destination of the highest-order cache server to another cache server.

Firstly, the contents server 50 detects the increase of its own load and searches for two cache servers A 61 and B 62 whose obtained contents are most overlapped among its connected cache servers.

Then, of the two cache servers A 61 and B 62, one with the larger obtained contents (for example, cache server A 61) and one with the smaller obtained contents (for example, cache server B 62) are specified as higher-order and lower-order ones, respectively. Then, the contents server 50 transmits a request for connecting the lower-order cache server B 62 to the higher-order cache server A 61, to the higher-order cache server A 61.

Then, the cache server A 61 receives the connect request and checks its own load. If the connection is possible, the cache server A 61 returns its response to the contents server 50 so.

Then, the contents server 50 updates its connection destination cache server information and notifies the cache server B 62 of the connection destination modification.

Then, after receiving the notice, the cache server B 62 updates its contents server information and cache server information and transmits a connect request to the cache server A 61.

Lastly, upon receipt of the connect request, the cache server A 61 updates its cache server information and transmits its response.

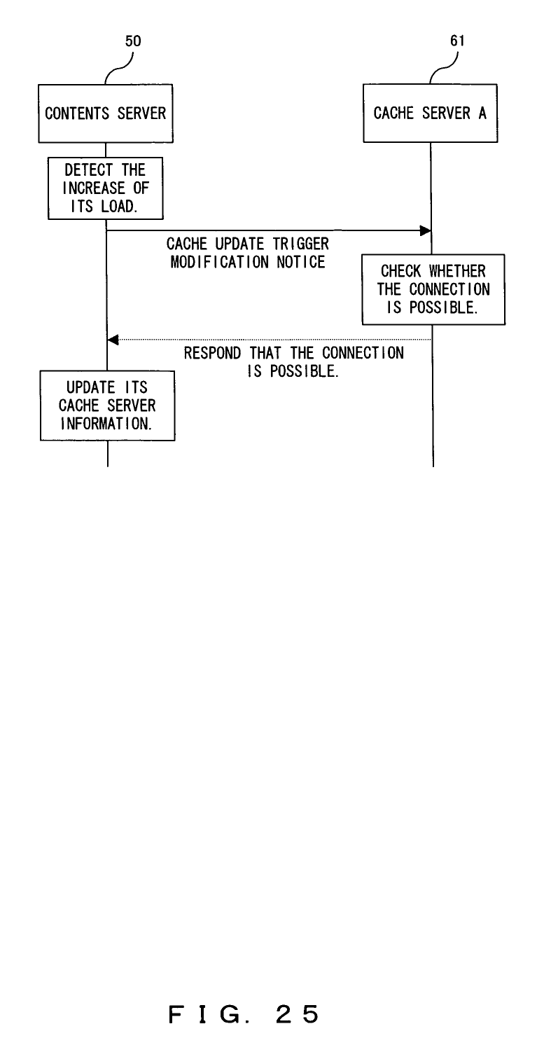

FIG. 25 shows an example of the operation of modifying cache update under the lead of a cache server to cache update under the lead of a contents sever.

Firstly, the contents server 50 detects a trigger for modifying a cache update operation, such as the increase of its load or the like.

Then, the contents server 50 transmits a cache update trigger modification notice to a cache server whose cache update operation is to be modified (for example, cache server A 61).

Then, upon receipt of the cache update trigger modification notice, the cache server A 61 transmits a response that the modification is possible if there is no problem in its own load. However, if there is a problem in its own load, the cache server A 61 transmits a response that the modification is impossible or a response that the modification is possible after modifying the connection destination of its subordinate cache server (cache server C 63 or D 64) to the contents server 50.

Lastly, upon the receipt of either of the responses, the contents server 50 stores the cache server update trigger modification.

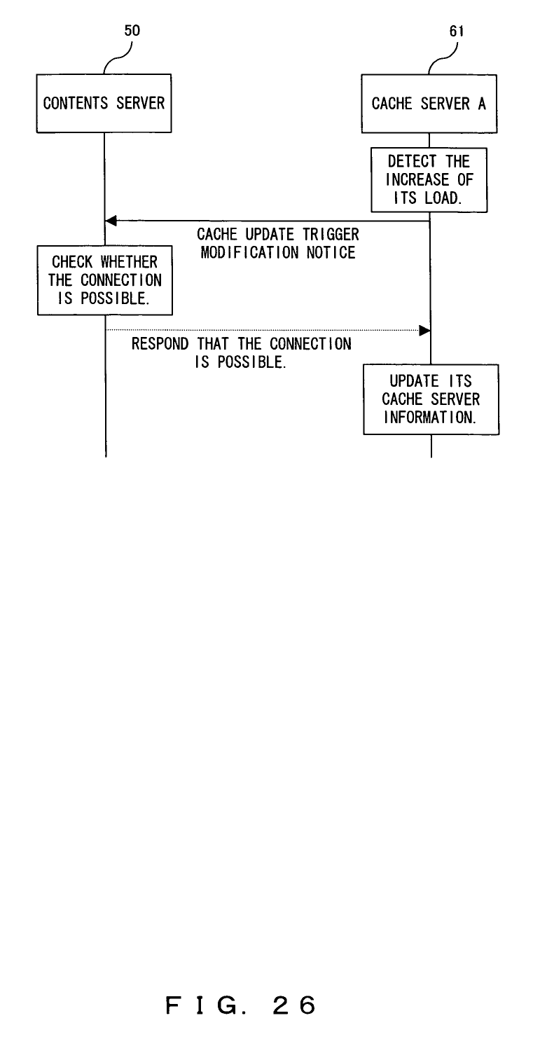

FIG. 26 shows an example of the operation of modifying cache update under the lead of a contents sever to cache update under the lead of a cache server.

Firstly, for example, the cache server A 61 detects a trigger for modifying a cache update operation, such as the increase of its load or the like.

Then, upon receipt of the cache update trigger modification notice, the contents server 50 transmits a response that the modification is possible if there is no problem in its own load. However, if there is a problem in its own load, the cache server A 61 transmits a response that the modification is impossible or a response that the modification is possible after modifying the connection destination of its subordinate cache server (cache server C 63 or D 64) to the cache server A 61.

Lastly, upon receipt of the cache update trigger modification notice, the cache server A 61 stores the cache server update trigger modification.

So far, examples of the operation of the contents delivery network (CDN) of the present invention have been described with reference to FIGS. 6 through 26.

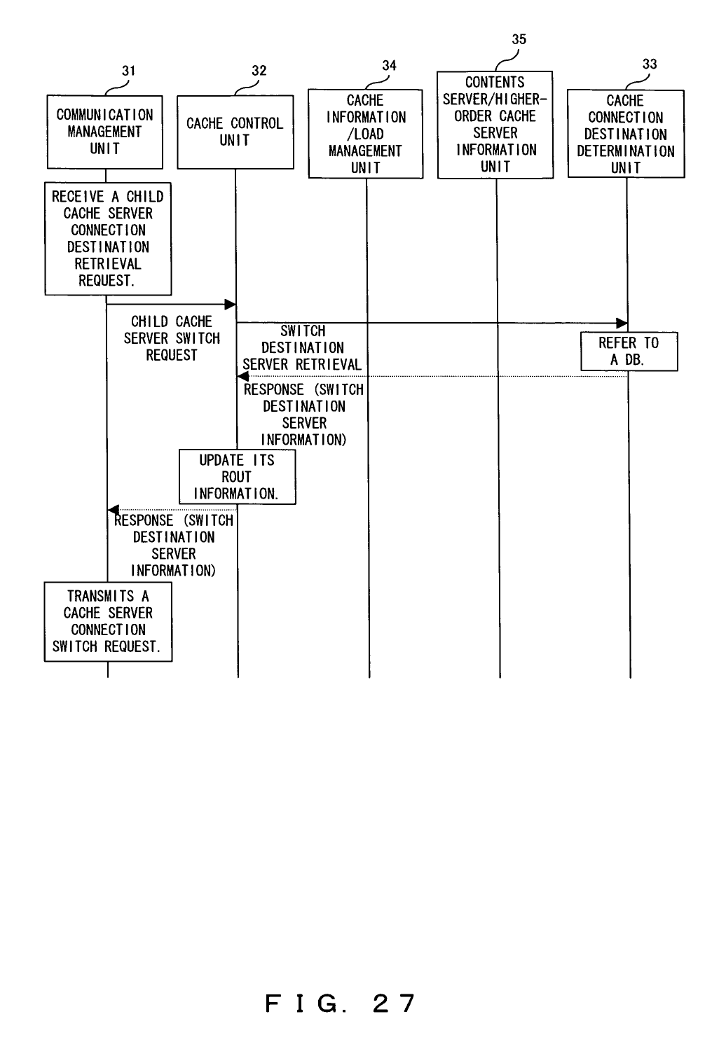

Next, examples of the operation of the cache server of the present invention are described with reference to FIGS. 27 through 36.

FIG. 27 shows an example of the operation of a cache server at the time of receiving a connection destination retrieval request.

Firstly, when receiving a connection destination retrieval request, the communication management unit 31 transfers the connection destination retrieval request to the cache control unit 32.

Then, the cache control unit 32 inquires the contents server/higher-order cache server information management unit 35. Impossible a database (DB), the contents server/higher-order cache server information management unit 35 searches for an optimal switch destination cache server 30. The cache control unit 32 receives information about the optimal switch destination cache server 30 from the contents server/higher-order cache server information management unit 35 as its response.

Then, the cache control unit 32 updates its route information and transfers the response including the information about the switch destination cache server to the communication management unit 31.

Lastly, the communication management unit 31 transmits a connection switch request to the switch destination cache server 30.

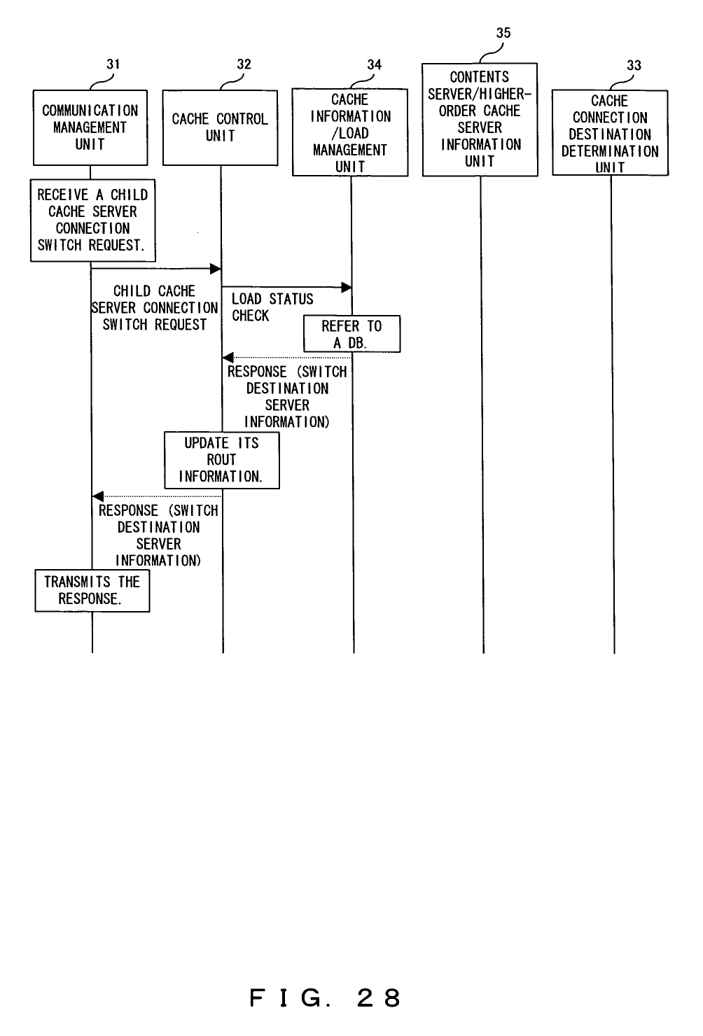

FIG. 28 shows an example of the operation of a cache server at the time of receiving a connection switch request.

Firstly, when receiving a connection switch request, the communication management unit 31 transfers the connection switch request to the cache control unit 32.

Then, the cache control unit 32 inquires the cache information/load management unit 34. Referring to a database (DB), the cache information/load management unit 34 checks its load status. The cache control unit 32 receives the load information from the cache information/load management unit 34 as its response.

Then, the cache control unit 32 update its route information and transfer the response to the communication management unit 31.

Lastly, the communication management unit 31 transmits the response to the cache server 30, which is the transmitting source of the connection switch request.

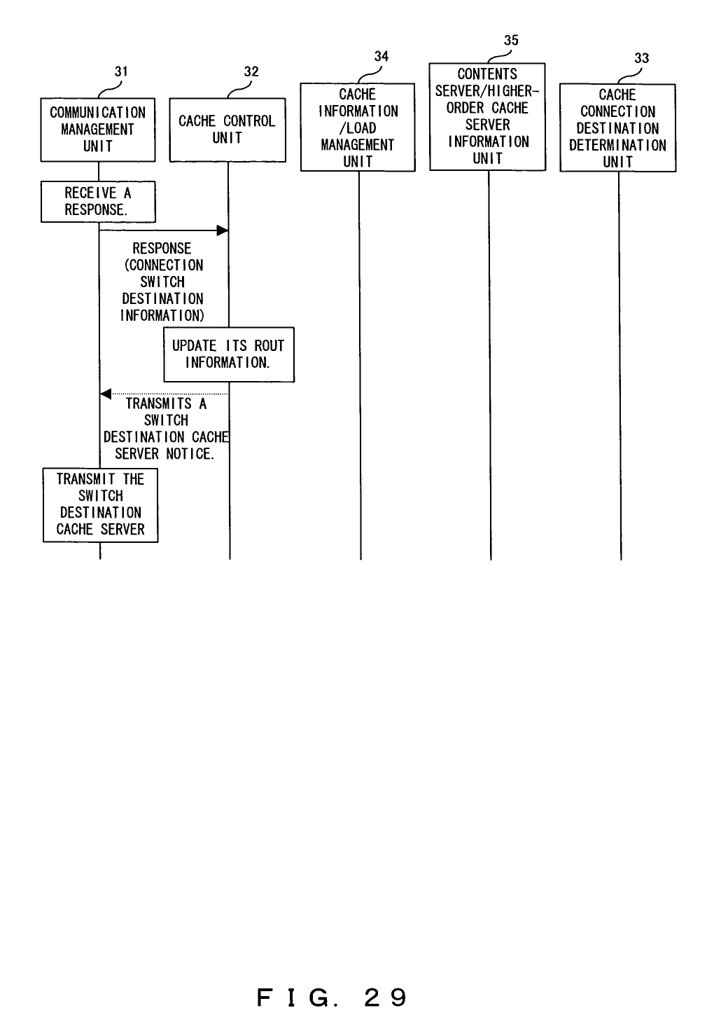

FIG. 29 shows an example of the operation of a cache server at the time of receiving a connection switch response.

Firstly, when receiving the response, the communication management unit 31 transfers the response to the cache control unit 32.

Then, the cache control unit 32 updates its route information and transfers a switch destination cache server notice to the communication management unit 31.

Lastly, the communication management unit 31 transmits the switch destination cache server notice to the prescribed cache server 30.

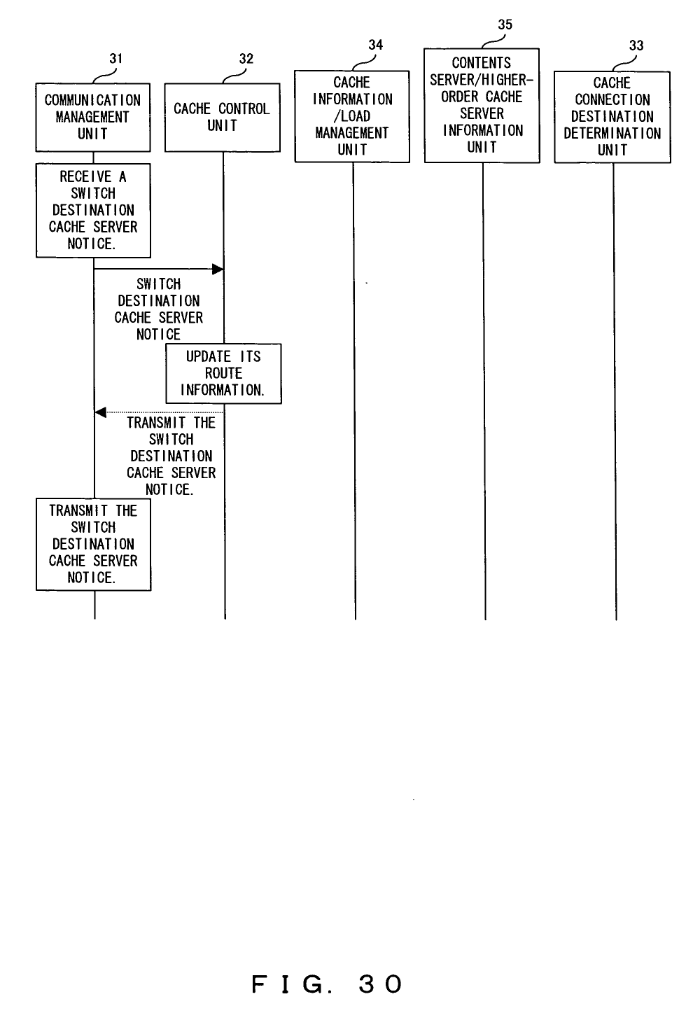

FIG. 30 shows an example of the operation of the parent cache server at the time of receiving a switch destination cache server notice.

Firstly, when receiving the switch destination cache server notice, the communication management unit 31 transfers the switch destination cache server notice to the cache control unit 32.

Then, the cache control unit 32 updates its route information and transfers the switch destination cache server notice to the communication management unit 31.

Lastly, the communication management unit 31 transmits the switch destination cache server notice to the prescribed cache server 30.

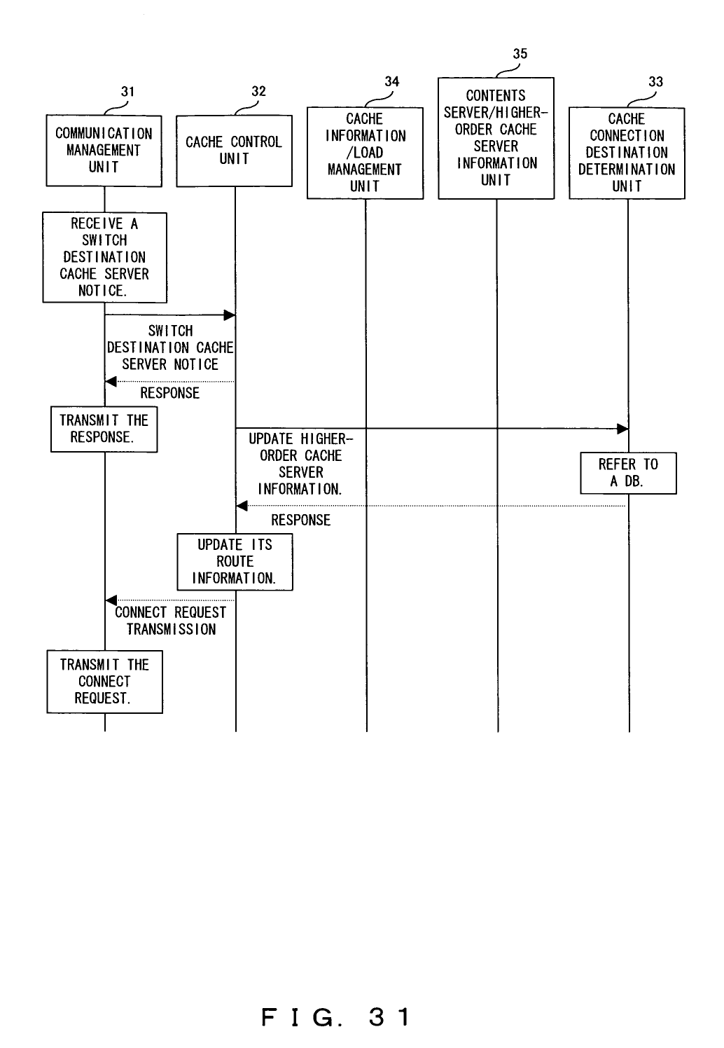

FIG. 31 shows an example of the operation of a child cache server at the time of receiving a switch destination cache server notice.

Firstly, when receiving the switch destination cache server notice, the communication management unit 31 transfers the switch destination cache server notice to the cache control unit 32.

Then, the cache control unit 32 transfers its response to the communication management unit 31.

Then, the communication management unit 31 transmits the response to the cache server 30, which is the transmitting source of the switch destination cache server notice.

Then, the cache control unit 32 instructs the contents server/higher-order cache server information management unit 35 to update higher-order cache server information.

Then, the contents server/higher-order cache server information management unit 35 updates the higher-order cache server information in the DB and returns its response to the cache control unit 32.

Then, the cache control unit 32 updates its route information and generates a connect request. Then, the cache control unit 32 transfers the connect request to the communication management unit 31.

Lastly, the communication management unit 31 transmits the connect request to the prescribed cache server 30.

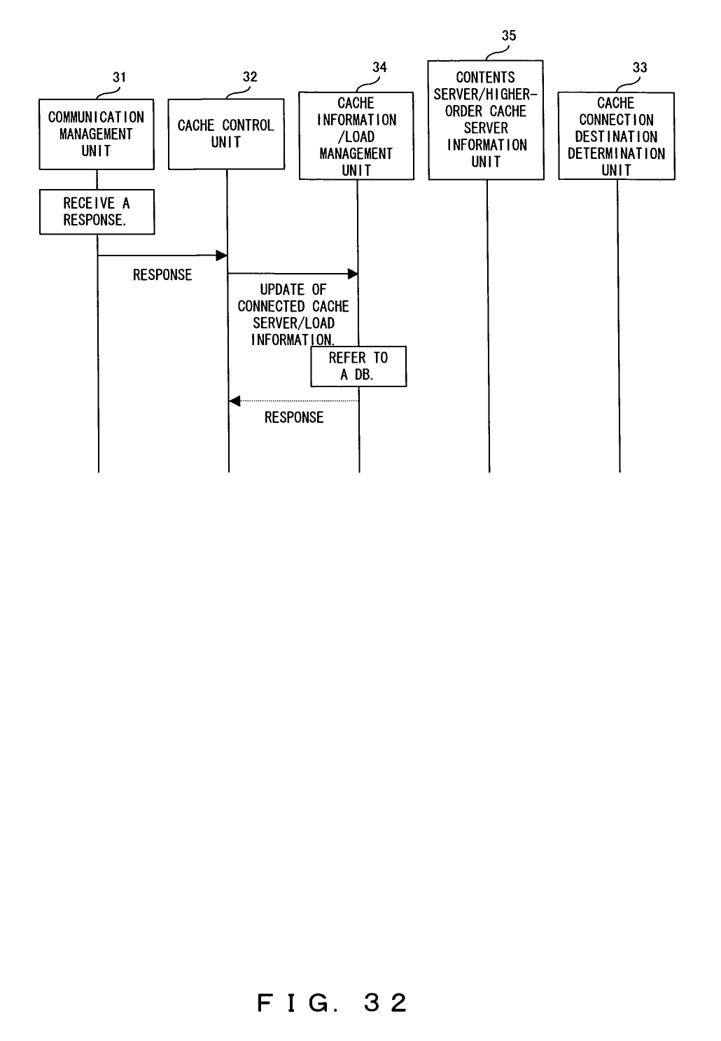

FIG. 32 shows an example of the operation of a cache server at the time of receiving a switch destination cache server notice response.

Firstly, when receiving the switch destination cache server notice response, the communication management unit 31 transfers the switch destination cache server notice response to the cache control unit 32.

Then, the cache control unit 32 instructs the cache information/load management unit 34 to update its connection destination cache server/load information.

Lastly, the cache information/load management unit 34 updates the connection destination cache server/load information and returns its response to the cache control unit 32.

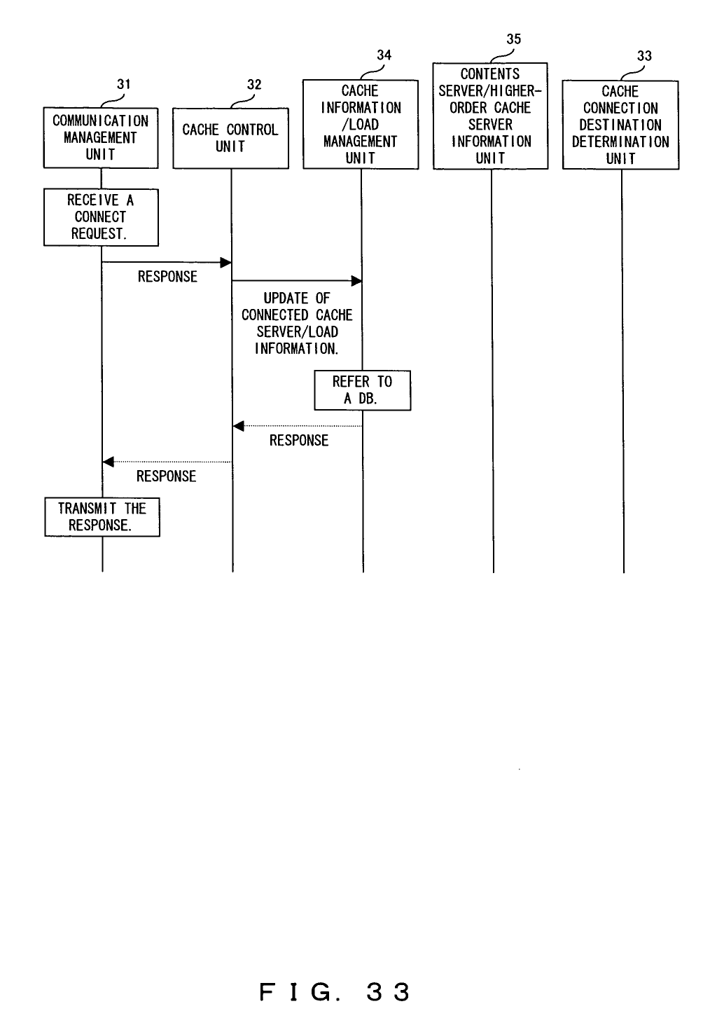

FIG. 33 shows an example of the operation of a cache server at the time of receiving a connect request.

Firstly, when receiving a connect request, the communication management unit 31 transfers the connect request to the cache control unit 32.

Then, the cache control unit 32 instructs the cache information/load management unit 34 to update the connected cache server/load information in the DB.

Then, the cache information/load management unit 34 updates the connection cache server/load information and returns its response to the cache control unit 32.

Then, the cache control unit 32 generates its response and transfers the response to the communication management unit 32.

Lastly, the communication management unit 31 transmits the response to request source cache server 30.

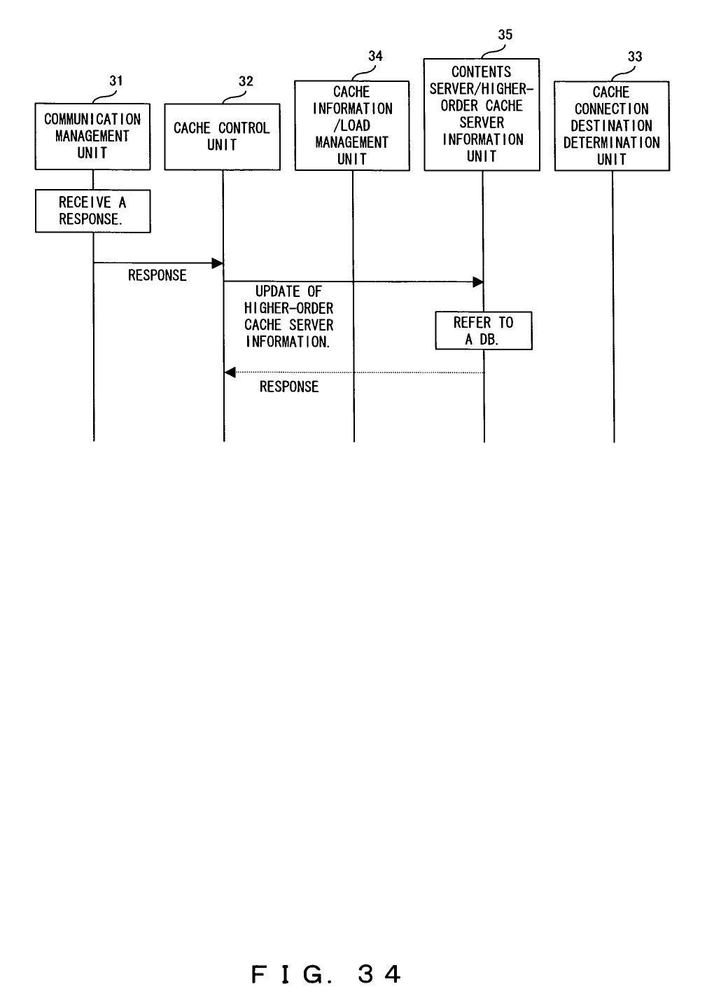

FIG. 34 shows an example of the operation of a cache server at the time of receiving a connect response.

Firstly, when receiving a connect response, the communication management unit 31 transfers the connect response to the cache control unit 32.

Then, the cache control unit 32 instructs the contents server/higher-order cache server information management unit 35 to update its higher-order cache server information.

Lastly, the contents server/higher-order cache server information management unit 35 updates the higher-order cache server information in the DB and returns its response to the cache control unit 32.

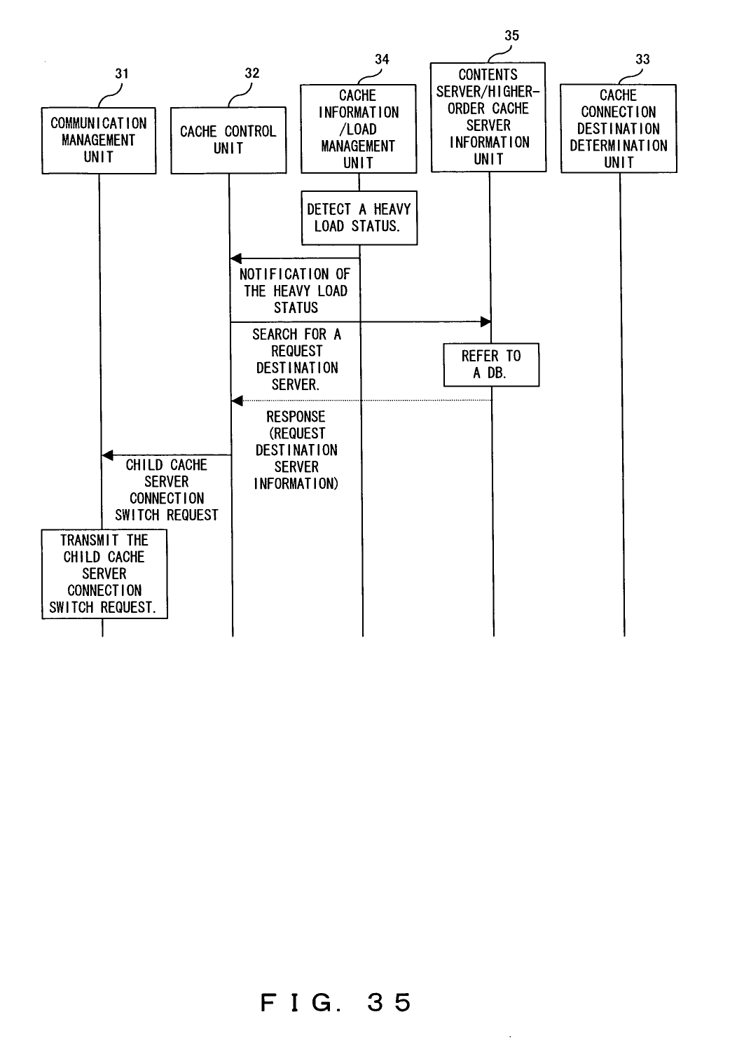

FIG. 35 shows an example of the operation of a cache server of transmitting a child cache server connection switch request to a higher-order server at the time of heavy load.

Firstly, when detecting its heavy load (overflown load) status, the cache information/load management unit 34 notifies the cache control unit 32 of the heavy load status.

Then, the cache control unit 32 inquires the contents server/higher-order cache server information management unit 35. The contents server/higher-order cache server information management unit 35 retrieves the request destination cache server 30 from the DB, and returns its response to the cache control unit 32.

Then, the cache control unit 32 receives request destination cache server information as a response and generates a connection destination retrieval request. Then, the cache control unit 32 transfers the connection destination retrieval request to the communication management unit 31 together with the request destination cache server information.

Lastly, the communication management unit 31 transmits the connection destination retrieval request to the switch request destination cache server 30.

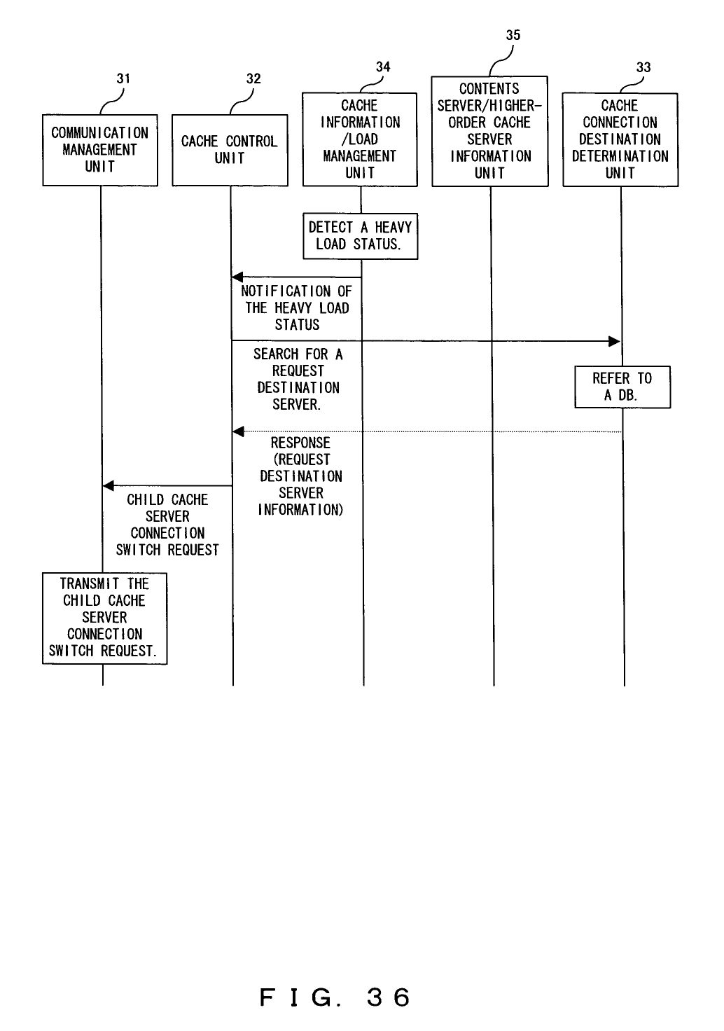

FIG. 36 shows an example of the operation of a cache server of transmitting a connection switch request to a child cache server at the time of heavy load.

Firstly, when detecting its heavy load status, the cache information/load management unit 34 notifies the cache control unit 32 of the heavy load status.

Then, the cache control unit 32 inquires the cache/connection destination determination unit 33. The cache/connection destination determination unit 33 retrieves the request destination cache server 30 from the database (DB) and returns its response to the cache control unit 32.

Then, the cache control unit 32 receives the request destination server information as its response and generates a child cache server connection switch request. Then, the cache control unit 32 transfers the child cache server connection switch request to the communication management unit 31 together with the request destination server information.

Lastly, the communication management unit 31 transmits the child cache server connection switch request to the request destination cache server 30.

So far, examples of the operation of the cache server of the present invention with reference to FIGS. 27 through 36.

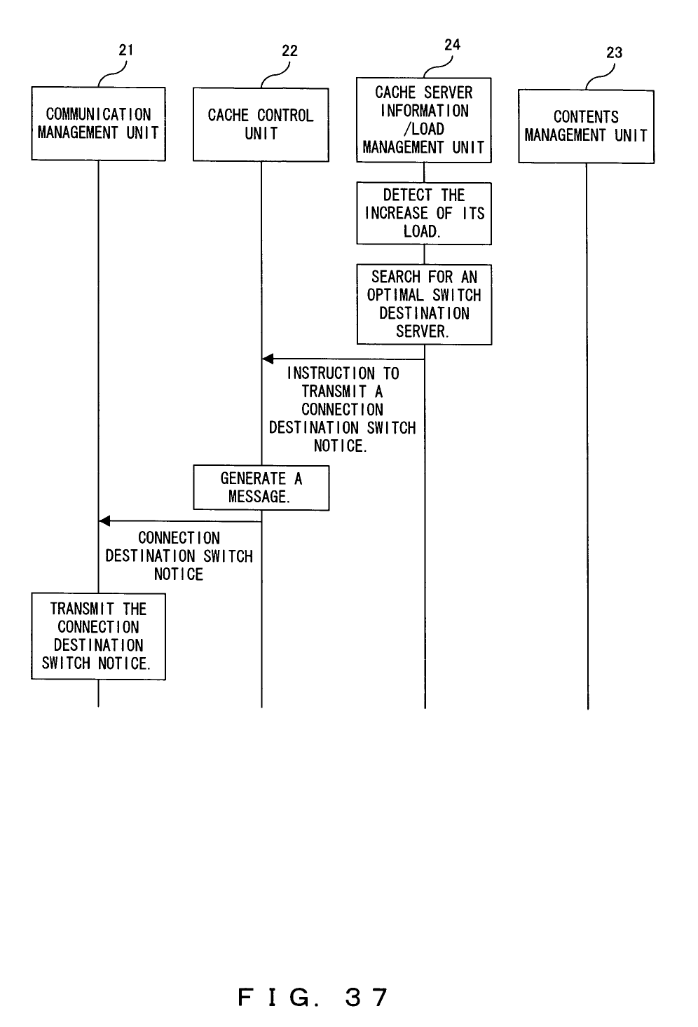

Next, examples of the operation of the contents server of the present invention are described with reference to FIGS. 37 through 42.

FIG. 37 shows an example of the operation of a contents sever in the case where a connection destination is switched due to the load status of the contents server.

Firstly, the cache server information/load management unit 24 selects a cache server 30 whose connection destination is switched and two switch destination cache servers 30 from cache servers connected to the contents server 20, based on their load statuses.

Then, the cache server information/load management unit 24 instructs the cache control unit 22 to transmit a connection switch destination notice.

Then, the cache control unit 22 generates a connection switch destination notice message and transfers the message to the communication management unit 21.

Lastly, the communication management unit 21 transmits the connection switch destination notice to the cache server whose connection destination is switched.

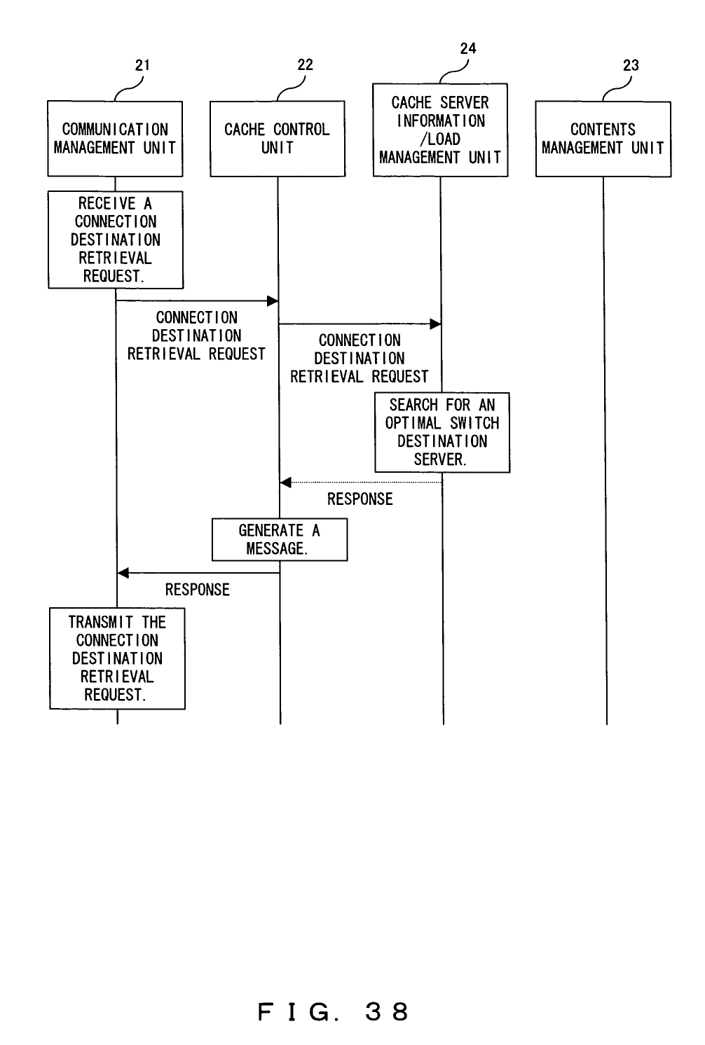

FIG. 38 shows an example of the operation of a contents sever at the time of receiving a connection destination retrieval request.

Firstly, the communication management unit 21 transfers a received connection destination retrieval request to the cache control unit 22.

Then, the cache control unit 22 inquires the cache server information/load management unit 24. The cache server information/load management unit 24 determines a cache server 30 which is the transmitting destination of the connection destination switch request by retrieving data from a database (DB) and returns its response to the cache control unit 22.

Lastly, the cache control unit 22 generates a connection destination switch request message and transmits the connection destination switch request to a cache server 30 with a prescribed address via the communication management unit 21.

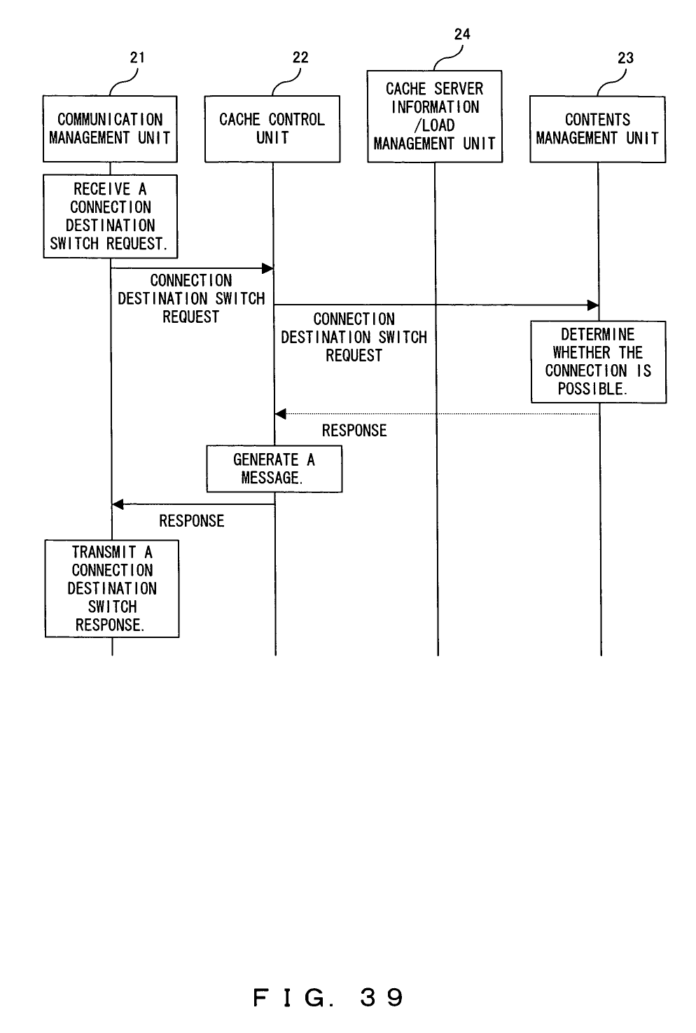

FIG. 39 shows an example of the operation of a contents sever at the time of receiving a connection destination switch request.

Firstly, the communication management unit 21 receives the connection destination switch request and transfers the received connection destination switch request to the cache control unit 22.

Then, the cache control unit 22 inquires the contents management unit 23. The contents management unit 23 determines whether the connection is possible and returns its response to the cache control unit 22.

Lastly, the cache control unit 22 generates a connection destination switch response message and transmits the message to a cache server 30 with a prescribed address via the communication management unit 21.

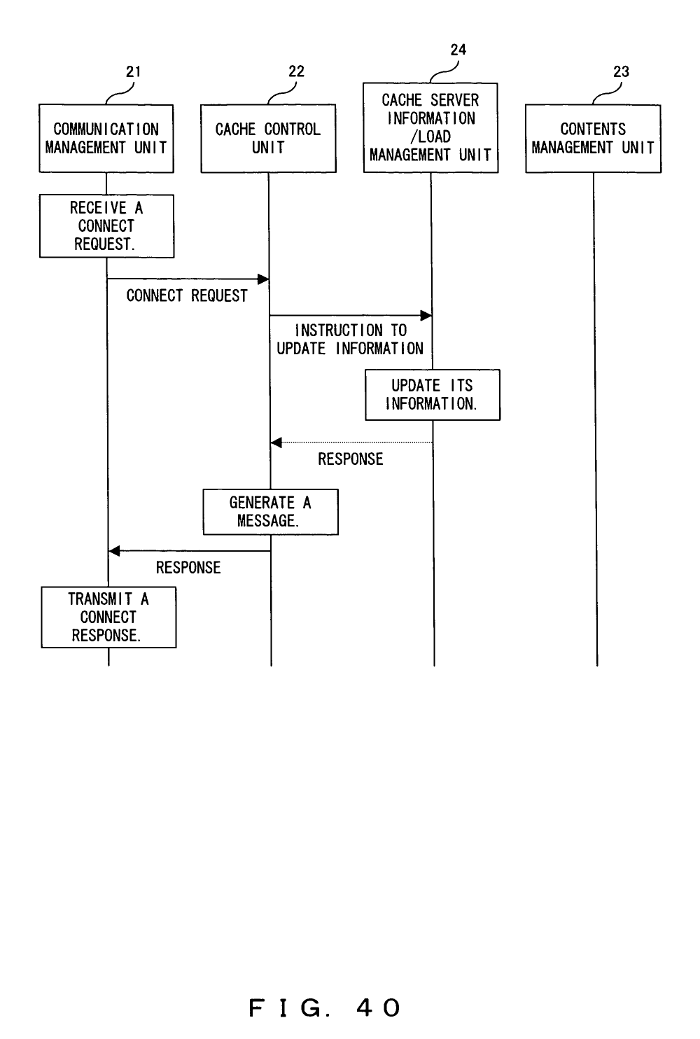

FIG. 40 shows an example of the operation of a contents sever at the time of receiving a connect request.

Firstly, the communication management unit 21 receives a connect request and transfers the received connect request to the cache control unit 22.

Then, the cache control unit 22 instructs the cache server information/load management unit 24 to update its information.

Then, the cache server information/load management unit 24 updates the information and returns its response to the cache control unit 22.

Lastly, the cache control unit 22 generates a connect response message and transmits the connect response message to a cache server with a prescribed address via the communication management unit 21.

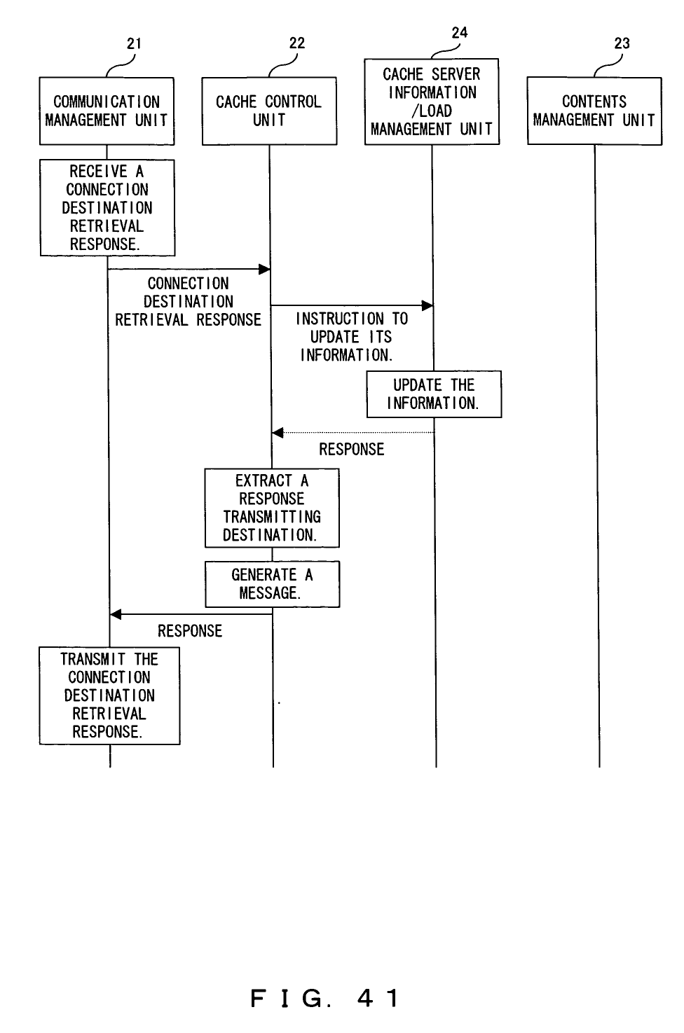

FIG. 41 shows an example of the operation of a contents sever at the time of receiving a connection destination retrieval response.

Firstly, the communication management unit 21 receives a connection destination retrieval response and transfers the received connection destination retrieval response to the cache control unit 22.

Then, the cache control unit 22 instructs the cache server information/load management unit 24 to updates its information if necessary.

Then, the cache server information/load management unit 24 updates the information and returns its response to the cache control unit 22.

Lastly, the cache control unit 22 extracts the transfer destination of the response from the received connection destination retrieval response and generates a connection destination retrieval response message. Then, the cache control unit 22 transmits the response to a cache server with a prescribed address via the communication management unit 21.

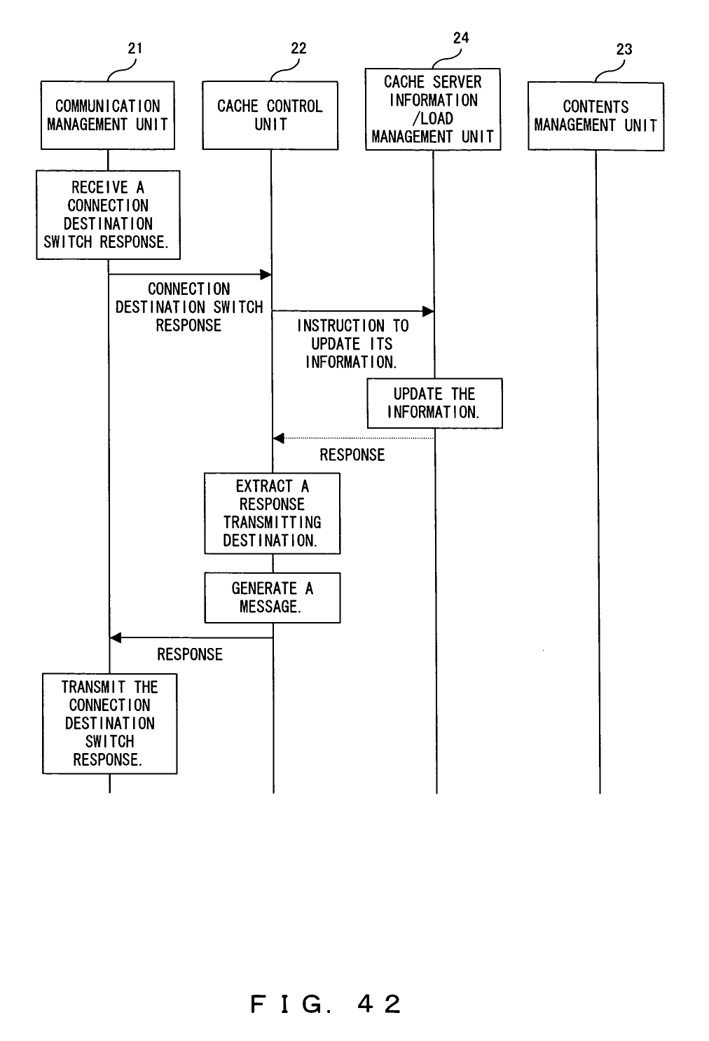

FIG. 42 shows an example of the operation of a contents sever at the time of receiving a connection destination switch response.

Firstly, the communication management unit 21 receives a connection destination switch response and transfers the received connection destination switch response to the cache control unit 22.

Then, the cache control unit 22 instructs the cache server information/load management unit 24 to updates its information if necessary.

Then, the cache server information/load management unit 24 updates the information and returns its response to the cache control unit 22.

Lastly, the cache control unit 22 extracts the transfer destination of the response from the received connection destination switch response and generates a connection destination switch response message. Then, the cache control unit 22 transmits the response to a cache server with a prescribed address via the communication management unit 21.

So far, examples of the operation of the contents server of the present invention have been described with reference to FIGS. 37 through 42.

The above-described preferred embodiments of the present invention can be realized by hardware as one function of a cache server or contents server, the firmware of a DSP board or CPU board, or software.

Although so far the preferred embodiments of the present invention have been described with reference to the drawings, the cache server or contents server of the present invention is not limited to the above-described as long as its function is executed. They can be a stand-alone device, a system or incorporated device which is composed of a plurality of devices, or a system in which a process is performed via a network, such as LAN, WAN or the like.

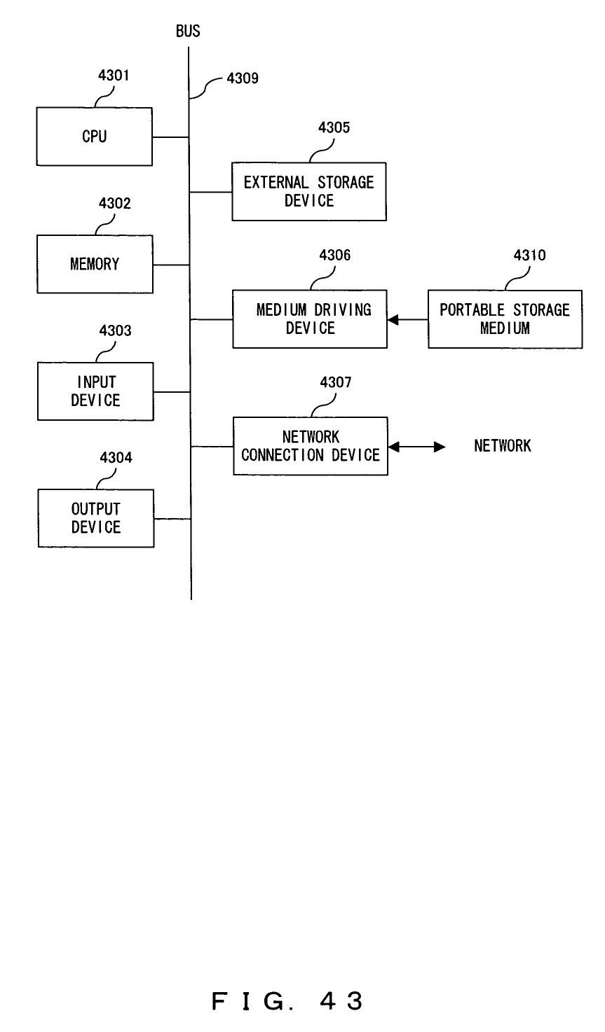

As shown in FIG. 43, they can be realized by a system comprising a CPU 4301, memory 4302, such as ROM or RAM, an input device 4303, an output device 4304, an external storage device 4305, a medium driving device 4306 and a network connection device 4307 which are connected by a bus 4309. Specifically, they can be realized by providing a cache server or contents server with the memory 4302, such as ROM or RAM on which is recorded a software program code for realizing a system in the above-described preferred embodiment, the external storage device 4305 and a portable storage medium 4310 and enabling the computer of the cache server or contents server to read and execute the program code.

In this case, the program code itself read from the portable storage medium 4310 or the like realizes the new function of the present invention, and the portable storage medium 4310 or the like recording the program code constitutes the present invention.

For the portable storage medium 4310 for providing the program code, a flexible disk, a hard disk, an optical disk, a magneto-optical disk, CD-ROM, CD-R, DVD-ROM, DVD-RAM, a magnetic tape, a non-volatile memory card, a ROM card, a variety of storage media recorded via the network connection device 4307, such as electronic mail, personal communication, etc. (in other words, communication line) or the like can be used.

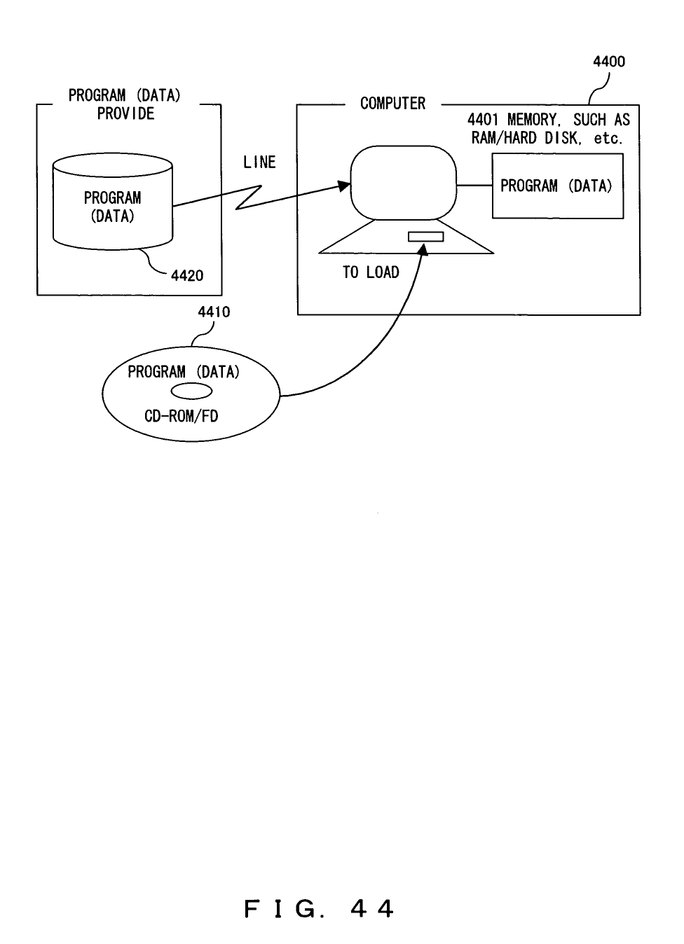

As shown in FIG. 44, the functions of the above-described preferred embodiments can be realized by enabling a computer (information processing device) 4400 to execute the program code read into memory 4401. Alternatively, they can be realized by enabling OS operating in the computer 4400 or the like to execute apart of the actual process or the entire process, based on the instruction of the program code.

Furthermore, the functions of the above-described preferred embodiments can also be realized by enabling a CPU provided for a function extension board or unit or the like to execute a part of the actual process or the entire process, based on the instruction of the program code after the program code read from the portable storage medium 4410 or a program (data) 4420 provided by a program (data) provider is written in memory 4401 provided for the function extension board inserted in or the function extension unit connected to the computer 4400.

In other words, the present invention is not limited to the above-described preferred embodiments, and can take various configurations or forms as long as they do not deviate from the subject matter of the present invention.

According to the present invention, even when there is a plurality of contents servers, being a contents delivery source, in other words, each cache server is controlled by a different manager, by distributing a load to each cache server, a logical network configuration can be dynamically modified according to the load of each cache server, thereby a larger-scaled network system can be realized.

According to the present invention, by distributing a load to each cache server, the amount of communication flowing through a network can also be reduced as a whole.

What is claimed is:

1. A cache server for caching contents in a contents server and delivering the contents to a client according to a request of the client, comprising:
a load measuring unit for measuring a load of a cache server, caused by a load source cache server subordinately connected to the cache server caching contents cached in the cache server;
an overflown load determination unit for determining whether a load measured by the load measuring unit is overflown, by comparing the load with a predetermined value;
a connection destination retrieval request information transmitting unit for transmitting a connection destination retrieval request for requesting the contents sever or another cache server to search for a connection destination of the load source cache server, which is its load source, if the overflown load determination unit determines that the load is overflown;
a connection destination information receiving unit for receiving the connection destination information indicating a connection destination retrieved by the contents sever or the other cache server from the contents sever or the other cache server, which is a transmitting destination, to which the connection destination retrieval request information transmitting unit has transmitted the connection destination retrieval request information; and
a switch request transmitting unit for transmitting a switch request information for requesting the load source cache server to switch a connection to the connection destination indicated in the connection destination information, based on the connection destination information received by the connection destination information receiving unit.

2. The cache server according to claim 1, wherein
the load of the cache server is measured based on a size of contents requested to the load source cache server.

3. The cache server according to claim 1, wherein
the load of the cache server is measured based on the number of clients requesting for access to the load source cache server.

4. The cache server according to claim 1, wherein
the load of the cache server is measured based on a frequency of access to the load source cache server.

5. The cache server according to claim 1, wherein
the load of the cache server is measured based on a degree of overlap between contents by cached by the cache server and contents of cached by the load source cache server.

6. The cache server according to claim 1, wherein
the connection destination retrieval request information transmitting unit transmits the connection destination retrieval request information to the contents server connected to the cache server or the other cache server in predetermined order.

7. The cache server according to claim 6, wherein
the connection destination retrieval request information transmitting unit sequentially transmits the connection destination retrieval request information to the contents server connected to the cache server or the other cache server highly ordered in a hierarchical contents delivery network of the contents server connected to the cache server or the other cache server.

8. The cache server according to claim 1, wherein
the connection destination retrieval request information transmitting unit transmits information about the load source cache server together with the connection destination retrieval request information.

9. The contents server according to claim 1, comprising:
a connection destination retrieval request information receiving unit for receiving a connection destination retrieval request for requesting to search for the connection destination of the load source cache server, which is the load source of the cache server, from the cache server according to claim 1;
a connection destination retrieval request transfer unit for transferring the connection destination retrieval request information to another cache server subordinately connected to the contents sever received by the connection destination retrieval request information receiving unit;
a connection destination possible/impossible determination result receiving unit for receiving a connection destination determination result indicating whether the server can be a connection destination of the load source cache server, from the other cache server which is a transfer destination to which the connection destination retrieval request information is transmitted;
a connection destination determining unit for determining whether the server can be a connection destination of the load source cache server, based on the load of the contents server if all the connection destination possible/impossible determination results received by the connection destination possible/impossible determination result receiving unit cannot be a connection destination of the load source cache server; and
a connection destination possible/impossible determination result transmitting unit for transmitting a connection destination possible/impossible determination result indicating whether the connection destination determined by the connection destination determination unit is possible.

10. The other cache server according to claim 1, comprising:
a connection destination retrieval request information receiving unit for receiving connection destination retrieval request information for requesting to search for the connection destination of a load source cache server, which is the load source of the cache server, from the contents server according to claim 9;
a connection destination determination unit for determining whether the server can be the connection destination of the load source cache server, based on a load of the cache server, included in the connection destination retrieval request information received by the connection destination retrieval request information receiving unit;
a connection destination retrieval request information transfer unit for transferring the connection destination retrieval request information to another cache server subordinately connected to the cache server if a connection destination possible/impossible determination result indicating whether the connection destination determined by the connection destination determination unit can be the connection destination of the load source cache server; and
a connection destination possible/impossible determination result transmitting unit for transmitting the connection destination possible/impossible determination result indicating whether the connection destination determined by the connection destination determination unit can be the connection destination of the load source cache server, to the contents server or cache server which has transmitted the connection destination retrieval request information.

11. The cache server according to claim 10, wherein
the connection destination retrieval request information transfer unit transfers the connection destination retrieval request information in predetermined order.

12. The other cache server according to claim 1, comprising:
a connection destination retrieval request information receiving unit for receiving connection destination retrieval request information for requesting to search for the connection destination of a load source cache server, which is the load source of the cache server, from the contents server according to claim 1;
a connection destination determination unit for determining whether the server can be the connection destination of the load source cache server, based on a load of the cache server, included in the connection destination retrieval request information received by the connection destination retrieval request information receiving unit;
a connection destination retrieval request information transfer unit for transferring the connection destination retrieval request information to another cache server subordinately connected to the cache server if a connection destination possible/impossible determination result indicating whether the connection destination determined by the connection destination determination unit can be the connection destination of the load source cache server; and
a connection destination possible/impossible determination result transmitting unit for transmitting the connection destination possible/impossible determination result indicating whether the connection destination determined by the connection destination determination unit can be the connection destination of the load source cache server, to the contents server or cache server which has transmitted the connection destination retrieval request information.

13. The cache server according to claim 12, wherein
the connection destination retrieval request information transfer unit transfers the connection destination retrieval request information in predetermined order.

14. A contents delivery network for delivering contents in a contents sever according to a request from a client, which comprises the contents server and cache server according to claim 1.

15. A connection destination server switching control method in a contents delivery network for delivering contents in a contents server, according to a request from a client, wherein
a cache server for caching the contents in the contents server
measures a load of the cache server, caused by a load source cache server subordinately connected to the cache server caching contents cached in the cache server and
transmits a connection destination retrieval request information for requesting the contents sever to search for a connection destination of the load source cache server, which is its load source, by comparing the measured load with a predetermined value if it is determined that the load is overflown,
the contents server
receives the connection destination retrieval request information transmitted from the cache server and
transfers the received connection destination retrieval request information to another cache server subordinately connected to the contents server,
the other cache server
determines whether the server can be a connection destination of the load source cache server, based on a load of the other cache server, included in the connection destination retrieval request information transferred by the contents server,
transmits connection destination possible/impossible determination result indicating whether the server can be the determined connection destination, to the contents server that has transmitted the connection destination retrieval request information,
the contents server
returns the received connection destination possible/impossible determination result to a load source cache server as the determined connection destination and
the load source cache server modifies the connection destination, based on the returned connection destination possible/impossible determination result.

16. A cache server for caching contents in a contents server and delivering the contents to a client according to a request of the client, comprising:
load measuring means for measuring a load of a cache server, caused by a load source cache server subordinately connected to the cache server caching contents cached in the cache server;
overflown load determination means for determining whether a load measured by the load measuring means is overflown, by comparing the load with a predetermined value;
connection destination retrieval request information transmitting means for transmitting a connection destination retrieval request for requesting the contents sever or another cache server to search for a connection destination of the load source cache server, which is its load source, if the overflown load determination means determines that the load is overflown;
connection destination information receiving means for receiving the connection destination information indicating a connection destination retrieved by the contents sever or the other cache server from the contents sever or the other cache server, which is a transmitting destination, to which the connection destination retrieval request information transmitting means has transmitted the connection destination retrieval request information; and
switch request transmitting means for transmitting a switch request information for requesting the load source cache server to switch a connection to the connection destination indicated in the connection destination information, based on the connection destination information received by the connection destination information receiving means.
